(19) United States
(12) Patent Application Publication
(10) Pub. No.: US 2026/0244845 A1
(43) Pub. Date: Aug. 20, 2026

(54) TEXT INPUT

(71) Applicant: University of Vermont and State Agricultural College, Burlington, VT (US)

(72) Inventors: Noah B. MANZ, South Burlington, VT (US); Varsha PUDI, Winooski, VT (US); Timothy E. BAUGH, Burlington, VT (US); Noah A. KOLB, Charlotte, VT (US)

(73) Assignee: University of Vermont and State Agricultural College, Burlington, VT (US)

(21) Appl. No.: 19/369,873

(22) Filed: Oct. 27, 2025

Related U.S. Application Data
(60) Provisional application No. 63/715,790, filed on Nov. 4, 2024.

(51) Int. Cl. G06F 40/166; G06F 3/0482; G06F 3/04886

(52) U.S. Cl. CPC G06F 40/166; G06F 3/0482; G06F 3/04886

(57) ABSTRACT

A non-intuitive typing approach that combines both the combinatorial and permutational methods to increase performance is described. Characters (e.g., letters) are input in a particular way (i.e., first character of intended word, followed by last character of intended word, followed by one or more “middle” characters of the intended word in any order).

### BACKGROUND

Amyotrophic Lateral Sclerosis (ALS) is a neurodegenerative disease of both upper and lower motor neurons, which are nerves from the brain and spinal cord responsible for both voluntary and respiratory muscle function. Worldwide, ALS affects 1.1 in 100,000 persons between the ages 18-50 and 21.4 in 100,000 persons aged >65 (Mehta, P. et al. (2023). Prevalence of amyotrophic lateral sclerosis in the United States, 2018. Amyotrophic Lateral Sclerosis and Frontotemporal Degeneration, 24(7-8), 702-708. https://doi.org/10.1080/21678421.2023.2245858). Symptoms in the early stages of the disease involve muscle twitching, cramping, spasticity, weakness, slurred or nasal speech, and/or difficulty chewing or swallowing. In the later and final stages of the disease, depending on the type, symptoms can progress to include loss of voluntary muscle control and extremity function, sialorrhea, constipation, inability to maintain adequate weight and nutrition, dysphagia, dysarthria, and eventual respiratory failure (“Amyotrophic Lateral Sclerosis (ALS)”, National Institute of Neurological Disorders and Stroke, last reviewed on Jul. 19, 2024 (https://www.ninds.nih.gov/health-information/disorders/amyotrophic-lateral-sclerosis-als)) Currently, there is no treatment to cure or reverse the effects of ALS.

Approved pharmacologic interventions include Riluzole, which reduces damage to motor neurons by decreasing levels of glutamate, or Edaravone and Sodium phenylbutyrate/taurursodiol, which reduce damage related to oxidative and other stress signals (“Amyotrophic Lateral Sclerosis (ALS)”, National Institute of Neurological Disorders and Stroke, last reviewed on Jul. 19, 2024 (https://www.ninds.nih.gov/health-information/disorders/amyotrophic-lateral-sclerosis-als)). Although the goal of these interventions is to slow disease progression, they are generally ineffective at extending life expectancy and increasing quality of life (Hoxhaj P. et al. (Sep. 18, 2023) Exploring Advancements in the Treatment of Amyotrophic Lateral Sclerosis: A Comprehensive Review of Current Modalities and Future Prospects. Cureus 15(9): e45489. doi: 10.7759/cureus.45489). Because of this, the focus of treatment for ALS is aimed towards nonpharmaceutical quality of life improvements; a few examples include, but are not limited to, physical therapy for fatigue and muscle stiffness, psychotherapy for depression and distress management, gastrotomy for inadequate nutrition maintenance, and noninvasive ventilation for respiratory failure in the late and end stages of disease progression (Hoxhaj P. et al. (Sep. 18, 2023) Exploring Advancements in the Treatment of Amyotrophic Lateral Sclerosis: A Comprehensive Review of Current Modalities and Future Prospects. Cureus 15(9): e45489. doi: 10.7759/cureus.45489). While initial symptoms typically do not interfere with speech intelligibility, 80-95% of patients at some point along disease progression will be unable to meet daily communication needs using natural speech alone (Hoxhaj P. et al. (Sep. 18, 2023) Exploring Advancements in the Treatment of Amyotrophic Lateral Sclerosis: A Comprehensive Review of Current Modalities and Future Prospects. Cureus 15(9): e45489. doi: 10.7759/cureus.45489). This loss of communication ability is noted as one of the top 3 worst aspects of ALS that patients express (Hoxhaj P. et al. (Sep. 18, 2023) Exploring Advancements in the Treatment of Amyotrophic Lateral Sclerosis: A Comprehensive Review of Current Modalities and Future Prospects. Cureus 15(9): e45489. doi: 10.7759/cureus.45489). In fact, the ability for communication/speech is featured in several ALS quality of life questionnaires including the ALSSQOL-R6, ALSSQOL-SF7, and ALSFRS-R-SE8.

In response to this, much research and development has been put into speech-generating devices to assist ALS patients. Some speech-generating devices utilize pre-existing recordings of messages via a two-pronged approach. The first approach is referred to as “message banking” which involves recording several meaningful phrases that patients can play on demand (e.g., as mp3 files). The second approach is referred to as “voice banking” which involves developing a synthesized voice that captures the unique intonation of a person's voice (Roman A. et al. (September 2021) Expanding Availability of Speech-Generating Device Evaluation and Treatment to People With Amyotrophic Lateral Sclerosis (pALS) Through Telepractice: Perspectives of pALS and Communication Partners. American Journal of Speech-Language 30(5): https://doi.org/10.1044/2021_AJSLP-20-00334). Typically, patients must record ~1,800 utterances that cover a set of diphones which are segmented and can be recombined as necessary to synthesize speech in the user's voice (Junichi Yamagishi et al., Speech synthesis technologies for individuals with vocal disabilities: Voice banking and reconstruction, Acoustical Science and Technology, 2012, Volume 33, Issue 1, Pages 1-5, Released on J-STAGE Jan. 1, 2012, Online ISSN 1347-5177, Print ISSN 1346-3969, https://doi.org/10.1250/ast.33.1, https://www.jstage.jst.go.jp/article/ast/33/1/33_1_1/articl e/-char/en). These recordings or synthesized voices are accessible to those who have the ability to type traditionally or through alternative methods that utilize limb, head, or eye movements to select the letters or messages to be communicated. Eye tracking software is highly effective because extraocular motor neurons are typically spared until the late stages of ALS (Linda K. McLoon, Vahid M. Harandi, Thomas Brännström, Peter M. Andersen, Jing-Xia Liu; Wnt and Extraocular Muscle Sparing in Amyotrophic Lateral Sclerosis. Invest. Ophthalmol. Vis. Sci. 2014; 55 (9): 5482-5496. https://doi.org/10.1167/iovs.14-14886). Though speech generating devices are effective at communicating pre-prepared messages, there are significant delays associated with new message composition, rendering the technology inadequate to facilitate real-time conversations and interactions (Higginbotham J et al. (2016). Time and timing in interactions involving individuals with ALS, their unimpaired partners and their speech generating devices (https://www.researchgate.net/publication/352357087_Time_and_timing_in_interactions_involvi ng_individuals_with_ALS_their_unimpaired_partners_and_their_speech_generating_devices/cit ation/download?_tp-eyJjb250ZXh0Ijp7ImZpcnN0UGFnZSI6InB1YmxpY2F0aW9uliwicGFnZ SI6InB1YmxpY2F0aW9uIn19)).

### SUMMARY

A first aspect of the present disclosure relates to a device comprising: at least one processor; and at least one memory comprising instructions that, when executed by the at least one processor, cause the device to: receive a first user input corresponding to a first character of an intended word or phrase to be displayed; determine, from a words storage, at least a first candidate word or phrase starting with the first character, wherein the words in the words storage are ranked based on a frequency of usage in a language; display the at least first candidate word or phrase; while or after displaying the at least first candidate word or phrase, receive a second user input corresponding to a last character of the intended word or phrase; determine, from the words storage, at least a second candidate word or phrase starting with the first character and ending with the last character; and display the at least second candidate word.

In some embodiments of the first aspect, the at least one memory further comprises instructions that, when executed by the at least one processor, further cause the device to: while or after displaying the at least second candidate word or phrase, receive a third user input corresponding to a further character of the intended word or phrase; determine, from the words storage, at least a third candidate word or phrase starting with the first character, ending with the last character, and including the further character between the first character and the last character; and display the at least third candidate word or phrase.

In some embodiments of the first aspect, the at least one memory further comprises instructions that, when executed by the at least one processor, further cause the device to, based on receiving the third user input, display the last character between the first character and the further character.

In some embodiments of the first aspect, the at least one memory further comprises instructions that, when executed by the at least one processor, further cause the device to, based on receiving the third user input, display the further character between the first character and the last character.

In some embodiments of the first aspect, the at least one memory further comprises instructions that, when executed by the at least one processor, further cause the device to: based on receiving the first user input, display the first character; and based on receiving the second user input: display the last character next to the first character; and while displaying the last character next to the first character, display an insertion point indicator of a graphical user interface between the first character and the last character.

In some embodiments of the first aspect, the at least one memory further comprises instructions that, when executed by the at least one processor, further cause the device to: receive a third user input selecting the second candidate word or phrase; and based on the third user input, display the second candidate word or phrase as the intended word or phrase with an empty character space positioned between the end of the intended word or phrase and an insertion point indicator of a graphical user interface.

In some embodiments of the first aspect, the instructions for displaying the at least first candidate word or phrase further comprise instructions that, when executed by the at least one processor, further cause the device to display the at least first candidate word or phrase based on the frequency of usage in the language.

In some embodiments of the first aspect, the instructions for displaying the at least second candidate word or phrase further comprise instructions that, when executed by the at least one processor, further cause the device to display the at least second candidate word or phrase based on the frequency of usage in the language.

In some embodiments of the first aspect, the at least one memory further comprises instructions that, when executed by the at least one processor, further cause the device to: based on the first user input, determine, from the words storage, a group of words or phrases starting with the first character; store the group of words or phrases in a second storage; and based on the second user input, determine the at least second candidate word or phrase from the group of words or phrases in the storage.

In some embodiments of the first aspect, the at least one memory further comprises instructions that, when executed by the at least one processor, further cause the device to: based on receiving the first user input, display the first character; determine a third word displayed next to the first character; and determine the at least first candidate word using the third word and the first character.

In some embodiments of the first aspect, the at least one memory further comprises instructions that, when executed by the at least one processor, further cause the device to: based on receiving the first user input, display the first character of the intended word; determine a third word displayed next to the first character of the intended word; and determine the at least first candidate word using the first character of the third word, the last character of the third word, and the first character of the intended word.

In some embodiments of the first aspect, the words storage includes n-gram character strings with space positions; and the at least one memory further comprises instructions that, when executed by the at least one processor, further cause the device to: generate manipulated n-gram character strings by removing the space positions from the n-gram character strings; and determine the at least first candidate word or phrase to corresponds to at least a first manipulated n-gram character string starting with the first character.

In some embodiments of the first aspect, the at least one memory further comprises instructions that, when executed by the at least one processor, further cause the device to determine the at least second candidate word or phrase to corresponds to at least a second manipulated n-gram character string starting with the first character and ending with the last character.

In some embodiments of the first aspect, the at least one memory further comprises instructions that, when executed by the at least one processor, further cause the device to: while or after displaying the at least second candidate word or phrase, receive a third user input corresponding to a further character of the intended word or phrase; and determine, from the words storage, at least a third candidate word or phrase starting with the first character, ending with the last character, and including the further character between the first character and the last character.

In some embodiments of the first aspect, the frequency of usage in the language corresponds to a cohort of users.

A second aspect of the present disclosure relates to a system comprising: at least one processor; and at least one memory comprising instructions that, when executed by the at least one processor, cause the system to: receive, from a user device, a first user input corresponding to a first character of an intended word or phrase to be displayed; determine, from a words storage, at least a first candidate word starting with the first character, wherein the words in the words storage are ranked based on a frequency of usage in a language; cause the user device to display the at least first candidate word or phrase; while or after causing the user device to display the at least first candidate word or phrase, receive a second user input corresponding to a last character of the intended word or phrase; determine, from the words storage, at least a second candidate word or phrase starting with the first character and ending with the last character; and cause the user device to display the at least second candidate word.

In some embodiments of the second aspect, the at least one memory further comprises instructions that, when executed by the at least one processor, further cause the system to: while or after displaying the at least second candidate word or phrase, receive a third user input corresponding to a further character of the intended word; determine, from the words storage, at least a third candidate word or phrase starting with the first character, ending with the last character, and including the further character between the first character and the last character; and display the at least third candidate word or phrase.

In some embodiments of the second aspect, the at least one memory further comprises instructions that, when executed by the at least one processor, further cause the system to, based on receiving the third user input, display the last character between the first character and the further character.

In some embodiments of the second aspect, the at least one memory further comprises instructions that, when executed by the at least one processor, further cause the system to, based on receiving the third user input, display the further character between the first character and the last character.

In some embodiments of the second aspect, the at least one memory further comprises instructions that, when executed by the at least one processor, further cause the system to: based on receiving the first user input, display the first character; and based on receiving the second user input: display the last character next to the first character; and while displaying the last character next to the first character, display an insertion point indicator of a graphical user interface between the first character and the last character.

In some embodiments of the second aspect, the at least one memory further comprises instructions that, when executed by the at least one processor, further cause the system to: receive a third user input selecting the second candidate word or phrase; and based on the third user input, display the second candidate word as the intended word or phrase with an empty character space positioned between the end of the intended word or phrase and an insertion point indicator of a graphical user interface.

In some embodiments of the second aspect, the instructions for displaying the at least first candidate word or phrase further comprise instructions that, when executed by the at least one processor, further cause the system to display the at least first candidate word or phrase based on the frequency of usage in the language.

In some embodiments of the second aspect, the instructions for displaying the at least second candidate word or phrase further comprise instructions that, when executed by the at least one processor, further cause the system to display the at least second candidate word or phrase based on the frequency of usage in the language.

In some embodiments of the second aspect, the at least one memory further comprises instructions that, when executed by the at least one processor, further cause the system to: based on the first user input, determine, from the words storage, a group of words or phrases starting with the first character; store the group of words or phrases in a second storage; and based on the second user input, determine the at least second candidate word or phrase from the group of words or phrases in the storage.

In some embodiments of the second aspect, the at least one memory further comprises instructions that, when executed by the at least one processor, further cause the system to: based on receiving the first user input, display the first character; determine a third word displayed next to the first character; and determine the at least first candidate word using the third word and the first character.

In some embodiments of the second aspect, the at least one memory further comprises instructions that, when executed by the at least one processor, further cause the system to: based on receiving the first user input, display the first character of the intended word; determine a third word displayed next to the first character of the intended word; and determine the at least first candidate word using the first character of the third word, the last character of the third word, and the first character of the intended word.

In some embodiments of the second aspect, the words storage includes n-gram character strings with space positions; and the at least one memory further comprises instructions that, when executed by the at least one processor, further cause the system to: generate manipulated n-gram character strings by removing the space positions from the n-gram character strings; and determine the at least first candidate word or phrase to corresponds to at least a first manipulated n-gram character string starting with the first character.

In some embodiments of the second aspect, the at least one memory further comprises instructions that, when executed by the at least one processor, further cause the system to determine the at least second candidate word or phrase to corresponds to at least a second manipulated n-gram character string starting with the first character and ending with the last character.

In some embodiments of the second aspect, the at least one memory further comprises instructions that, when executed by the at least one processor, further cause the system to: while or after displaying the at least second candidate word or phrase, receive a third user input corresponding to a further character of the intended word or phrase; and determine, from the words storage, at least a third candidate word or phrase starting with the first character, ending with the last character, and including the further character between the first character and the last character.

In some embodiments of the second aspect, the frequency of usage in the language corresponds to a cohort of users.

A third aspect of the present disclosure relates to a computer-implemented method comprising: receiving a first user input corresponding to a first character of an intended word or phrase to be displayed; determining, from a words storage, at least a first candidate word or phrase starting with the first character, wherein the words in the words storage are ranked based on a frequency of usage in a language; displaying the at least first candidate word or phrase; while or after displaying the at least first candidate word or phrase, receiving a second user input corresponding to a last character of the intended word or phrase; determining, from the words storage, at least a second candidate word or phrase starting with the first character and ending with the last character; and displaying the at least second candidate word.

In some embodiments of the third aspect, the method further comprises: while or after displaying the at least second candidate word or phrase, receiving a third user input corresponding to a further character of the intended word or phrase; determining, from the words storage, at least a third candidate word or phrase starting with the first character, ending with the last character, and including the further character between the first character and the last character; and displaying the at least third candidate word or phrase.

In some embodiments of the third aspect, the method further comprises, based on receiving the third user input, displaying the last character between the first character and the further character.

In some embodiments of the third aspect, the method further comprises, based on receiving the third user input, displaying the further character between the first character and the last character.

In some embodiments of the third aspect, the method further comprises: based on receiving the first user input, displaying the first character; and based on receiving the second user input: displaying the last character next to the first character; and while displaying the last character next to the first character, displaying an insertion point indicator of a graphical user interface between the first character and the last character.

In some embodiments of the third aspect, the method further comprises: receiving a third user input selecting the second candidate word or phrase; and based on the third user input, displaying the second candidate word or phrase as the intended word or phrase with an empty character space positioned between the end of the intended word or phrase and an insertion point indicator of a graphical user interface.

In some embodiments of the third aspect, displaying the at least first candidate word or phrase further comprises displaying the at least first candidate word or phrase based on the frequency of usage in the language.

In some embodiments of the third aspect, displaying the at least second candidate word or phrase further comprises displaying the at least second candidate word or phrase based on the frequency of usage in the language.

In some embodiments of the third aspect, the method further comprises: based on the first user input, determining, from the words storage, a group of words or phrases starting with the first character; storing the group of words or phrases in a second storage; and based on the second user input, determining the at least second candidate word or phrase from the group of words or phrases in the storage.

In some embodiments of the third aspect, the method further comprises: based on receiving the first user input, displaying the first character; determining a third word displayed next to the first character; and determining the at least first candidate word using the third word and the first character.

In some embodiments of the third aspect, the method further comprises: based on receiving the first user input, displaying the first character of the intended word; determining a third word displayed next to the first character of the intended word; and determining the at least first candidate word using the first character of the third word, the last character of the third word, and the first character of the intended word.

In some embodiments of the third aspect, the words storage includes n-gram character strings with space positions; and the computer-implemented method further comprises: generating manipulated n-gram character strings by removing the space positions from the n-gram character strings; and determining the at least first candidate word of phrase to corresponds to at least a first manipulated n-gram character string starting with the first character.

In some embodiments of the third aspect, the method further comprises determining the at least second candidate word or phrase to corresponds to at least a second manipulated n-gram character string starting with the first character and ending with the last character.

In some embodiments of the third aspect, the method further comprises: while or after displaying the at least second candidate word or phrase, receiving a third user input corresponding to a further character of the intended word or phrase; and determining, from the words storage, at least a third candidate word or phrase starting with the first character, ending with the last character, and including the further character between the first character and the last character.

In some embodiments of the third aspect, the frequency of usage in the language corresponds to a cohort of users.

A fourth aspect of the present disclosure relates to one or more non-transitory computer-readable storage media comprising instructions that, when executed by at least one processor, cause a device or system to: receive a first user input corresponding to a first character of an intended word or phrase to be displayed; determine, from a words storage, at least a first candidate word or phrase starting with the first character, wherein the words in the words storage are ranked based on a frequency of usage in a language; display the at least first candidate word or phrase; while or after displaying the at least first candidate word or phrase, receive a second user input corresponding to a last character of the intended word or phrase; determine, from the words storage, at least a second candidate word or phrase starting with the first character and ending with the last character; and display the at least second candidate word.

In some embodiments of the fourth aspect, the at least one memory further comprises instructions that, when executed by the at least one processor, further cause the device or system to: while or after displaying the at least second candidate word or phrase, receive a third user input corresponding to a further character of the intended word or phrase; determine, from the words storage, at least a third candidate word or phrase starting with the first character, ending with the last character, and including the further character between the first character and the last character; and display the at least third candidate word or phrase.

In some embodiments of the fourth aspect, the at least one memory further comprises instructions that, when executed by the at least one processor, further cause the device or system to, based on receiving the third user input, display the last character between the first character and the further character.

In some embodiments of the fourth aspect, the at least one memory further comprises instructions that, when executed by the at least one processor, further cause the device or system to, based on receiving the third user input, display the further character between the first character and the last character.

In some embodiments of the fourth aspect, the at least one memory further comprises instructions that, when executed by the at least one processor, further cause the device or system to: based on receiving the first user input, display the first character; and based on receiving the second user input: display the last character next to the first character; and while displaying the last character next to the first character, display an insertion point indicator of a graphical user interface between the first character and the last character.

In some embodiments of the fourth aspect, the at least one memory further comprises instructions that, when executed by the at least one processor, further cause the device or system to: receive a third user input selecting the second candidate word or phrase; and based on the third user input, display the second candidate word as the intended word or phrase with an empty character space positioned between the end of the intended word or phrase and an insertion point indicator of a graphical user interface.

In some embodiments of the fourth aspect, the instructions for displaying the at least first candidate word or phrase further comprise instructions that, when executed by the at least one processor, further cause the device or system to display the at least first candidate word or phrase based on the frequency of usage in the language.

In some embodiments of the fourth aspect, the instructions for displaying the at least second candidate word or phrase further comprise instructions that, when executed by the at least one processor, further cause the device or system to display the at least second candidate word or phrase based on the frequency of usage in the language.

In some embodiments of the fourth aspect, the at least one memory further comprises instructions that, when executed by the at least one processor, further cause the device or system to: based on the first user input, determine, from the words storage, a group of words or phrases starting with the first character; store the group of words or phrases in a second storage; and based on the second user input, determine the at least second candidate word or phrase from the group of words or phrases in the storage.

In some embodiments of the fourth aspect, the at least one memory further comprises instructions that, when executed by the at least one processor, further cause the device or system to: based on receiving the first user input, display the first character; determine a third word displayed next to the first character; and determine the at least first candidate word using the third word and the first character.

In some embodiments of the fourth aspect, the at least one memory further comprises instructions that, when executed by the at least one processor, further cause the device or system to: based on receiving the first user input, display the first character of the intended word; determine a third word displayed next to the first character of the intended word; and determine the at least first candidate word using the first character of the third word, the last character of the third word, and the first character of the intended word.

In some embodiments of the fourth aspect, the words storage includes n-gram character strings with space positions; and the one or more non-transitory computer-readable storage media further comprises instructions that, when executed by the at least one processor, further cause the device or system to: generate manipulated n-gram character strings by removing the space positions from the n-gram character strings; and determine the at least first candidate word or phrase to corresponds to at least a first manipulated n-gram character string starting with the first character.

In some embodiments of the fourth aspect, the at least one memory further comprises instructions that, when executed by the at least one processor, further cause the device or system to determine the at least second candidate word or phrase to corresponds to at least a second manipulated n-gram character string starting with the first character and ending with the last character.

In some embodiments of the fourth aspect, the at least one memory further comprises instructions that, when executed by the at least one processor, further cause the device or system to: while or after displaying the at least second candidate word or phrase, receive a third user input corresponding to a further character of the intended word or phrase; and determine, from the words storage, at least a third candidate word or phrase starting with the first character, ending with the last character, and including the further character between the first character and the last character.

In some embodiments of the fourth aspect, the frequency of usage in the language corresponds to a cohort of users.

### BRIEF DESCRIPTION OF DRAWINGS

For a more complete understanding of the present disclosure, reference is now made to the following description taken in conjunction with the accompanying drawings.

FIGS. 1A-1E illustrate example display configurations that may be presented to a user.

FIGS. 2A-2E illustrate further example display configurations that may be presented to a user.

FIG. 3 is a process flow diagram illustrating a device-implemented method for determining and displaying an intended word.

FIGS. 4A-4B are a signal flow diagram illustrating system-implemented method for determining and displaying an intended word.

FIG. 5 is a process flow diagram illustrating an example method for determining candidate words.

FIG. 6 is a process flow diagram illustrating another example method for determining candidate words.

FIG. 7 is a process flow diagram illustrating a further example method for determining candidate words.

FIG. 8 is process flow diagram illustrating another example method for determining candidate words.

FIG. 9 is a block diagram conceptually illustrating example components of a device.

FIG. 10 is a block diagram conceptually illustrating example components of a system component(s).

FIG. 11 is a chart of data (n=3) comparing the input speed of the herein disclosed text input technique to control methods for the sentence “Hello Word”.

FIG. 12 is a plot of the number of theoretical word matches by specifying the terminal letter in the herein disclosed text input technique compared to a combinatorial approach. In both cases, the same number of characteristic letters are input so, the number of keystrokes remains the same. FIG. 12 is for a word of length m=8 letters.

FIG. 13 is a plot of real-world data from a simulation on 10,000 English words showing how the herein disclosed text input technique results in fewer matches for a given (n=4) query compared to a combinatorial approach. Using the herein disclosed technique, users are more quickly able to narrow down a search to their intended word without the need for inputting additional characters.

FIG. 14 is a plot of the number of theoretical word matches for a permutational approach compared to the herein disclosed text input technique. In both cases, the same number of characteristic letters are input, so the number of keystrokes remains the same.

FIG. 15 is a plot of real-world data from simulation on 10,000 English words comparing the herein disclosed text input technique to a permutational approach with an n=4 query. The herein disclosed text input technique results in a 24% increase in word matches compared to the theoretical 163%. This is a result of the underlying orthographic (spelling) structure of the English language.

FIG. 16 is a violin plot of expected keystroke values for the herein disclosed and permutational text input methods for all 5, 6, 7, and 8 letter words. A violin plot was used to illustrate the interesting multi-modal distributions. Note not only the reduced mean/median keystroke value for the herein disclosed text input technique, but also the significantly reduced variance of the distribution. This results in a more predictable and more consistent typing experience for the user.

### DETAILED DESCRIPTION

### Overview

Some approaches to solving the typing speed limitation, such as the live-to-eye communication coined by Ezzat et al. (Blink-To-Live eye-based communication system for users with speech impairments. Sci Rep 13, 7961 (2023). https://doi.org/10.1038/s41598-023-34310-9) rely on a combination of eye movements to encode longer pre-defined sentences. For ALS patients, these are often phrases such as “Change my position to sitting” or “My wheelchair is not working” and may be represented by eye movement sequences such as up/down/left/left. While these sequences are an improvement from typing a message verbatim with a virtual keyboard, the general approach is limited due to the sheer number of combinations which must be memorized to communicate effectively. Furthermore, as this is effectively a base 4 system, maintaining a traditional alphanumeric approach increases the base to 26 drastically increasing the practical vocabulary size.

The present disclosure provides an Output through Simplified Text Entry and Response (FOSTER) methodology designed to increase communication speeds for users (e.g., ALS patients with dysarthria). To understand the benefits of the present disclosure, it is helpful to consider the basic statistical properties of the English language.

$$f ( k , N ) = \frac{1}{{H}_{N} k} , {H}_{N} = {\sum }_{k = 1}^{N} \frac{1}{k} \qquad Equation 1$$

Equation 1, Zipf's Law (Piantadosi ST. Zipf s word frequency law in natural language: a critical review and future directions. Psychon Bull Rev. 2014 October; 21(5):1112-30. doi: 10.3758/s13423-014-0585-6. PMID: 24664880; PMCID: PMC4176592) is an empirical observation often holding true in natural languages, which suggests that there is a small subset of highly used words which account for a large proportion of overall word usage. f(k, N) represents the usage frequency of the kth most commonly used word from a set of size N. In the English language, “the” is the most commonly used word accounting for ~7% of all word use, so Equation 1 may be modified to an equality by multiplying by a factor of 0.07. Considering an average college student vocabulary of 16,785 words (Körner, S., Siniawski, M., Kollewe, K., Rath, K. J., Krampfl, K., Zapf, A., . . . Petri, S. (2012). Speech therapy and communication device: Impact on quality of life and mood in patients with amyotrophic lateral sclerosis. Amyotrophic Lateral Sclerosis and Frontotemporal Degeneration, 14(1), 20-25. https://doi.org/10.3109/17482968.2012.692382), the frequency of the least commonly used word is just ~0.04% and occurs only once in very ~2500 words. In fact, ~4,300 words account for ~90% of all used English. The average length of these top 4,300 most commonly used words is 6.7 letters which implies an effective base of just 3.5 letters. In other words, just 3 unique characters is enough to uniquely re-spell ~90% of English text using an average word size of 7. By contrast, the unique 26 letters in the English alphabet are enough to uniquely generate the most common 4300 words (90% of English text) with only 2.6 characters. This suggests that a vast majority of conversational fluency could be maintained with a 3-character proxy for longer English words. Adopting these proxies could in theory lead to higher typing speeds (up to a theoretical 60%), which may drastically serve to increase communication speeds.

Instead of asking users to learn new ways to spell words, the teachings of the present disclosure may be used in conjunction with certain “characteristic” query characters (e.g., letters) to help narrow down the corpus of words to a more manageable subset. Of course, this approach is not specific enough to identify one unique word from the entire corpus, but by preferentially returning matches which appear close to the top of a frequency-ranked list, words that the user is more likely to type are more likely to be displayed first. The teachings of the present disclosure provide a non-intuitive typing approach to input characters (e.g., letters) in a particular way to improve performance.

In general, word search algorithms are either of the permutational or combinatorial type, where query letter order does and does not matter, respectively. These are the so-called intuitive typing approaches, which would be immediately familiar to most people.

The present disclosure provides a non-intuitive typing approach that combines both the combinatorial and permutational methods to increase performance and relies on characters (e.g., letters) being input in a very particular way, hence “non-intuitive.” Specifically, the teachings of the present disclosure require that the terminal (or last) character of an intended word be input as the second character in a query string following the intended word's leading (or first) character.

This constitutes the permutational aspect of the typing approach disclosed herein. After the last character is input, any amount of additional characters (i.e., characters located between the first and last characters) of the intended word may be input in a combinatorial fashion. The foregoing non-intuitive text input approach may be represented as:
[First character][Last character][Any # of other characters in any order]

Through initial testing, the herein disclosed text input approach has proven to be highly effective and predictive, and is capable of providing the intended word in the absence of any underlying semantic context. Furthermore, it may be implemented algorithmically with only a few steps: (1) collect the first character from the user (e.g., “i”); (2) display the top n words (e.g., in frequency ranked order) that start with the first character (e.g., “in”, “is”, and “it”); (3) if the intended word is not shown, collect a second character from the user (e.g., “e”); (4) display the top n words (e.g., in frequency ranked order) that start with the first character and end with the second character (e.g., “image”, “insurance”, and “include”); (5) if the intended word is not shown, collect another character from the user (e.g., “v”); (6) display the top n words (e.g., in frequency ranked order) that start with the first character, end with the second character, and contain the additional character anywhere in the middle (e.g., “improve”, “interactive”, and “initiative”); and (7) if the intended word is not shown, revert to Step 5 and add an additional character. Steps 5-7 may be repeated indefinitely until the intended word is obtained.

Through a detailed analysis of both theory and empirical data, the present disclosure established the herein disclosed text input technique addresses the shortcomings of both combinational and permutational word search/prediction approaches. Specifically, the herein disclosed text input technique converges faster than the combinatorial approach, leading to less overall possible word matches for a given query. The herein disclosed text input technique also significantly reduces the expected number of keystrokes for word prediction compared to the permutational approach. As a hybrid approach involving features of both a combinatorial and permutational method, the herein disclosed text input technique is able to result in a more specific selection of possible words with less overall character input from the user. This performance increase therefore makes the herein disclosed text input technique a useful tool for implementing word prediction functions, such as eye-tracking software for, e.g., ALS users with dysarthria.

The herein disclosed text input approach to word prediction constitutes a very lightweight overhead architecture (i.e., no large computational requirements for a Natural Language Model) and can be implemented using regular expressions and simple query length checks.

Gold standard communication technologies available to ALS patients utilize text-to-speech software in combination with an eye-tracking system to allow the user to type messages via a virtual keyboard. However, communication speeds remain markedly low. The herein disclosed text input approach fundamentally changes the way a user inputs text and leverages an important statistical property of language for word prediction. By predicting a user's intended word from only a few characters input in a particular order, significantly faster communication speeds may be obtained.

In some instances, the herein disclosed text input approach may utilize an API for text-to-speech processing.

The herein disclosed text input approach may be integrated with existing eye-tracking hardware to produce the same speech synthesis as current gold standard technologies, but in a significantly more efficient manner.

By increasing the rate of text entry using the herein disclosed text input approach, users (e.g., ALS patients with dysarthria) are given a chance to communicate at near-conversational speeds.

### Graphical User Interface

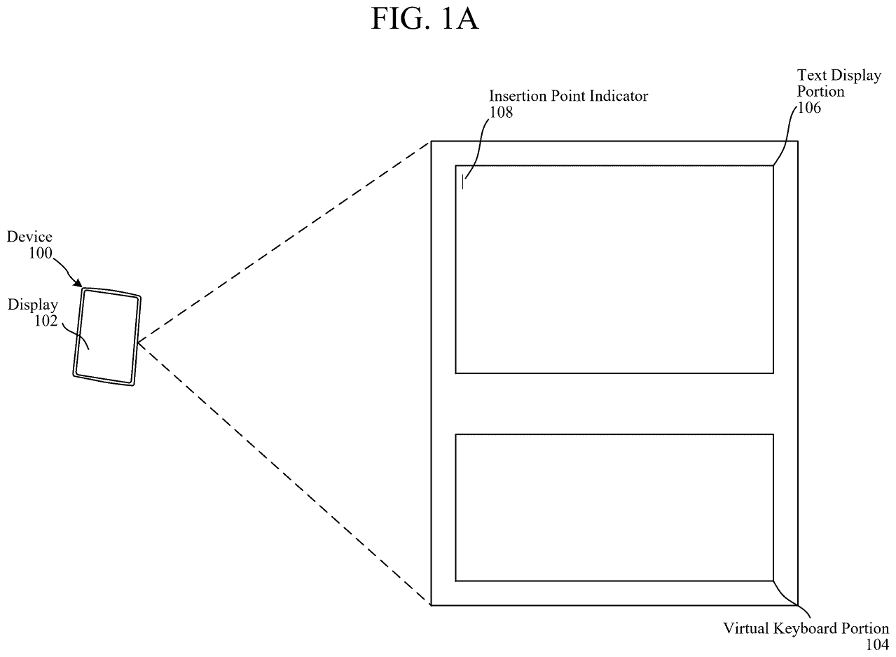

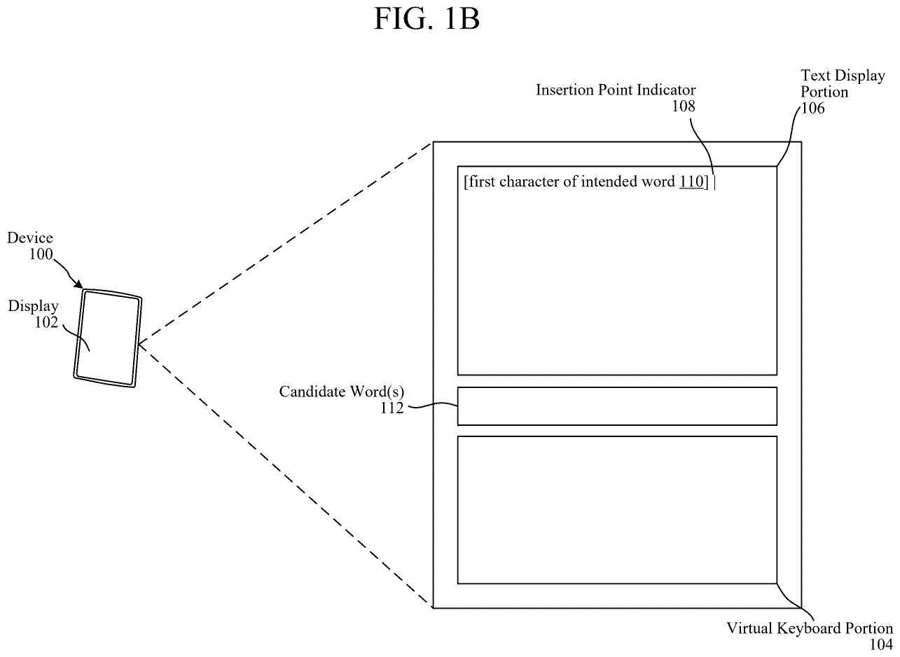

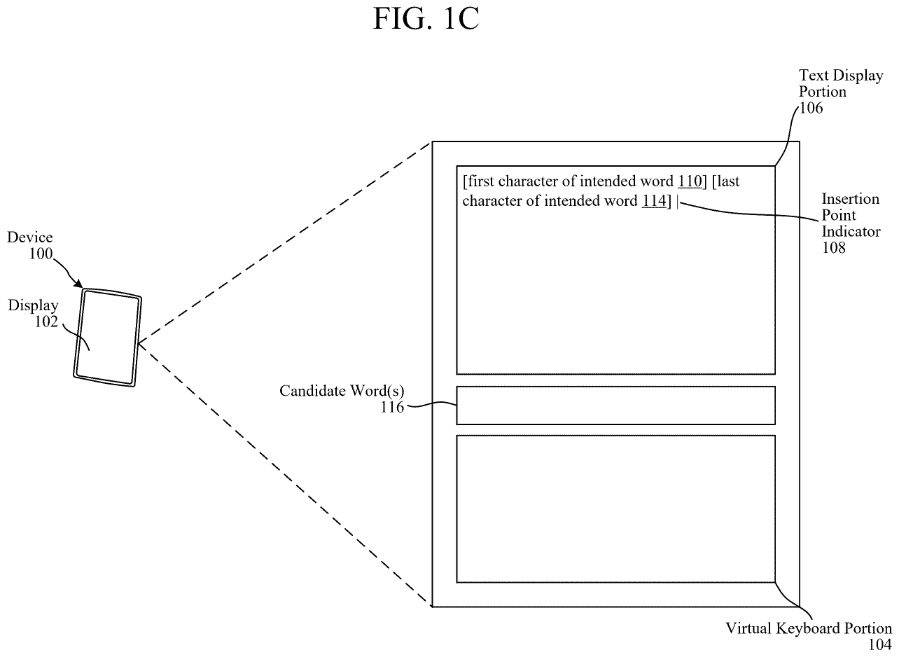

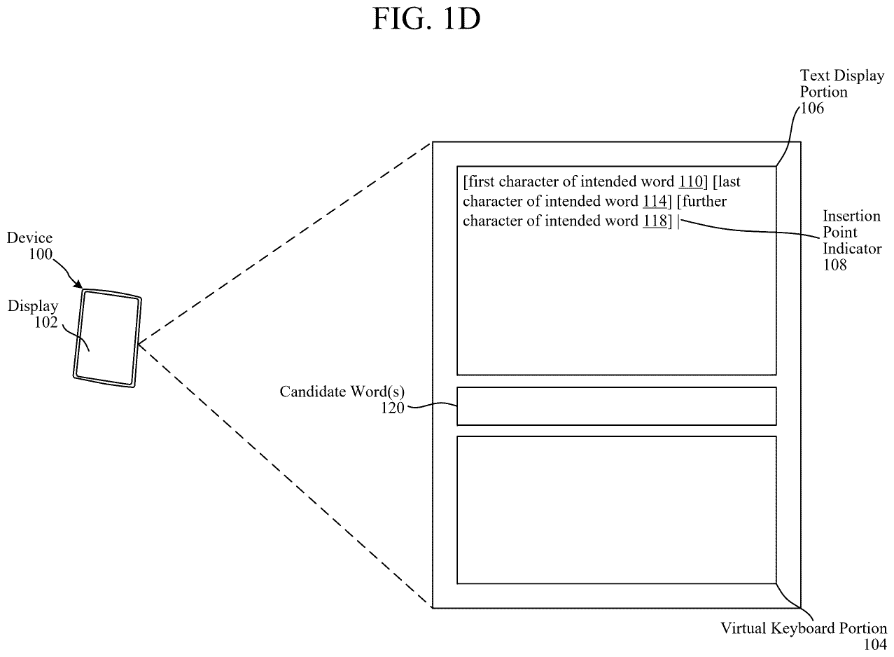

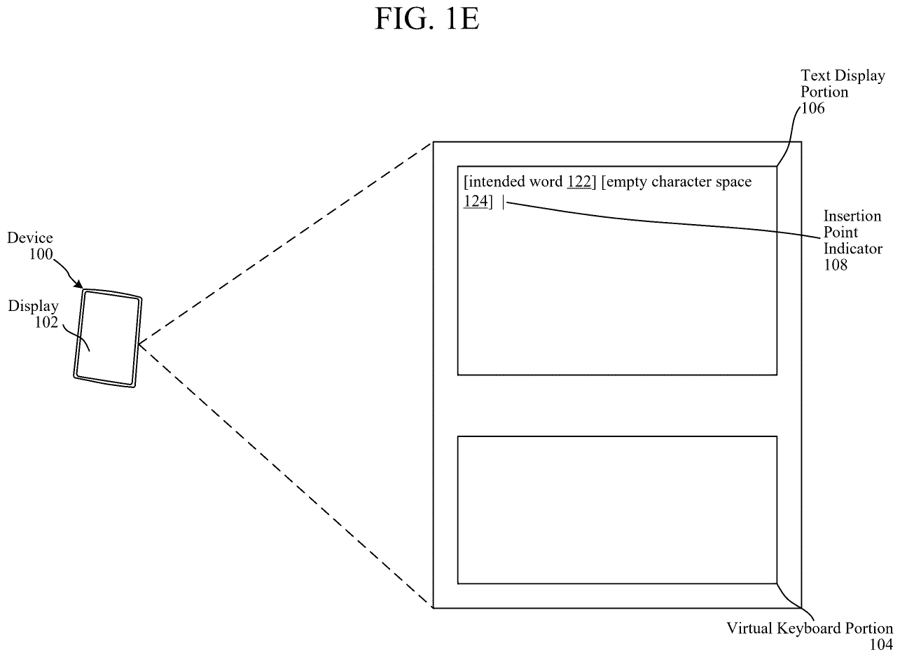

FIGS. 1A-1E illustrate example display configurations that may be presented to a user in accordance with teachings of the present disclosure. As illustrated in FIG. 1A, a user may have a device 100 including a display 102. The device 100 may be a smartphone, tablet, laptop, or any other device (i) having a display capable of presenting a virtual keyboard and (ii) including or being in data communication with at least one camera capable of detecting where a user's gaze is focused on the display. Moreover, the device 100 may be a smartphone, tablet, laptop, or any other device (i) having a display and (ii) a physical keyboard integrated or in data communication with the device 100.

The keyboard include the characters of any language as the text input approach disclosed herein is not limited to any particular language. For example, the keyboard may include English alphabet characters, Latin characters, Arabic alphabet characters, Armenian characters, Greek alphabet characters, Cyrillic characters, Hangul characters, Chinese alphabet characters, Hebrew characters, Devanagari characters, Braille characters, Georgian characters, etc.

In the example of FIG. 1A, the display 102 may include a virtual keyboard portion 104 where a virtual keyboard is presented. However, as noted above, the display 102 need not include the virtual keyboard portion 104 if the device 100 has or is in data communication with a physical keyboard.

The display 102 may also include a text display portion 106 where input text may be presented to the user. Within the text display portion 106, an insertion point indicator 108 may be presented to indicate to the user where the next input character will be displayed.

FIG. 1B illustrates a configuration of the display 102 after the user has input a first character 110 of an intended word. A user input of the present disclosure may take on any number of forms. For example, the user may provide an input by physically touching a portion of a touchscreen display. For further example, the user may provide an input by physically engaging a button of a physical keyboard. As another example, the user may provide an input by staring at a portion of the display 102 and blinking. A user input may be received via, for example, a push-button keyboard, a virtual keyboard, a finger or stylus interacting with a touchscreen, an image from a camera, real or virtual buttons on a remote, or input buttons on a device such as a game controller, mobile phone, mp3 player, computing pad, or other device.

In response to receiving the first character input, the device 100 may display the first character 110 in the text display portion 106. The device 100 may further display the insertion point indicator 108 next to (e.g., to the right of) the first character 110 in the text display portion 106.

Moreover, in response to receiving the first character input from the user, the device 100 may, as described in detail herein below, determine one or more candidate words 112 starting with the first character 110. The device 100 may display the one or more candidate words 112 using a portion of the display 102.

While the first character 110 of the intended word and the one or more candidate words 112 are displayed, the user may input the last character 114 of the intended word. Referring to FIG. 1C, in response to receiving the last character input, the device 100 may display the last character 114 in the text display portion 106 next to the first character 110. The device 100 may further display the insertion point indicator 108 next to (e.g., to the right of) the last character 114 in the text display portion 106.

Moreover, in response to receiving the last character input from the user, the device 100 may, as described in detail herein below, determine one or more candidate words 116 starting with the first character 110 and ending with the last character 114. The device 100 may display the one or more candidate words 116 using a portion of the display 102.

While the first character 110 and last character 114 of the intended word and the one or more candidate words 116 are displayed, the user may input a further character 118 of the intended word. The further character 118 may be any character of the intended word that is located between the first character 110 and the last character 114. The further character 118 need not (but can be) the “second” character of the intended word.

Referring to FIG. 1D, in response to receiving the further character input, the device 100 may display the further character 118 in the text display portion 106 next to the last character 114. The device 100 may further display the insertion point indicator 108 next to (e.g., to the right of) the further character 118 in the text display portion 106.

Moreover, in response to receiving the further character input from the user, the device 100 may, as described in detail herein below, determine one or more candidate words 120 starting with the first character 110, ending with the last character 114, and including the further character 118 somewhere between the first character 110 and the last character 114. The device 100 may display the one or more candidate words 120 using a portion of the display 102.

At some point, a displayed candidate word may be the intended word. When this happens, the user may provide an input selecting the candidate word as the intended word. As shown in FIG. 1E, in response to receiving this user input, the device 100 may display the intended word 122 in the text display portion 106. For example, if the user selects a candidate word 112, the device 100 may cease displaying the first character 110 and instead display the intended word 122. For further example, if the user selects a candidate word 116, the device 100 may cease displaying the first character 110 and the last character 114, and instead display the intended word 122. As another example, if the user selects a candidate word 120, the device 100 may cease displaying the first character 110, the last character 114, and the further character 118, and instead display the intended word 122.

Upon displaying the intended word 122, the device 100 may display the insertion point indicator 108 next to (e.g., to the right of) the intended word 122 in the text display portion 106. Moreover, in some embodiments the device 100 may, upon displaying the intended word 122 (and without receiving a separate user input from the one selecting the candidate word as the intended word), display an empty character space 124 between the intended word 122 and the insertion point indicator 108. This prevents the need of the user providing a “space” input to move the insertion point indicator 108 the empty character space 124 away from the intended word 122. As such, the user's input, following the selection of a candidate word as an intended word, may be the first character of another intended word.

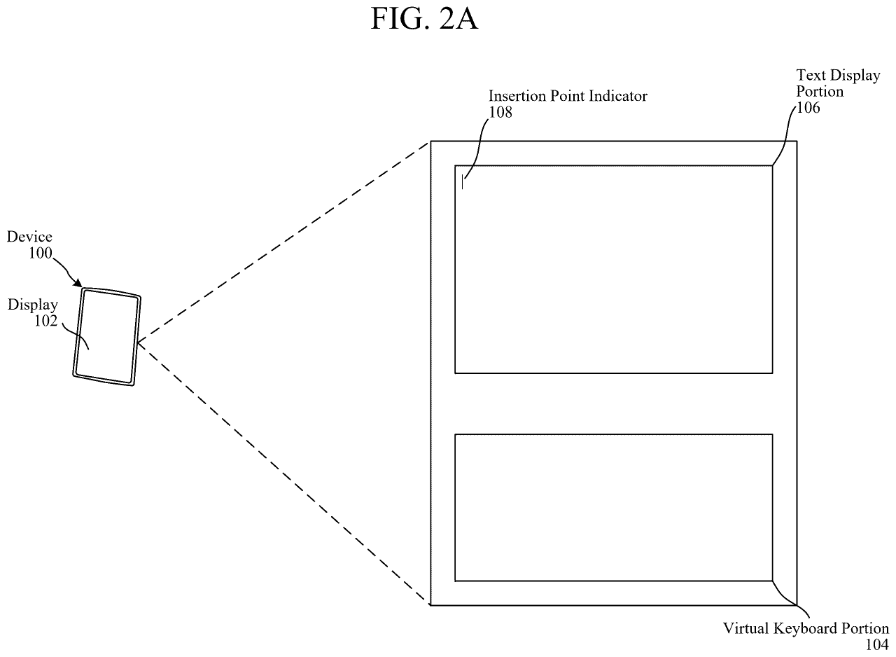

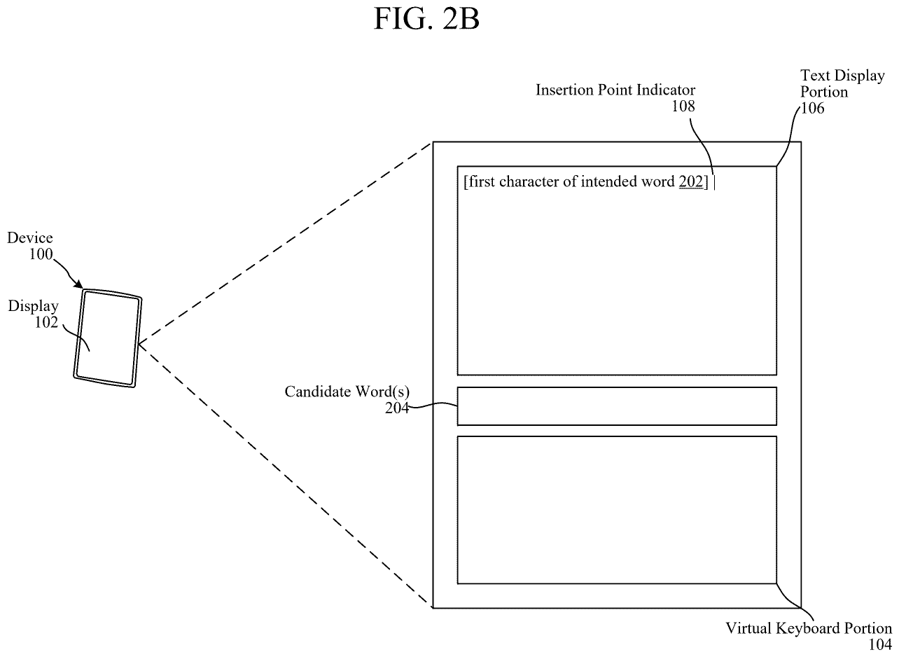

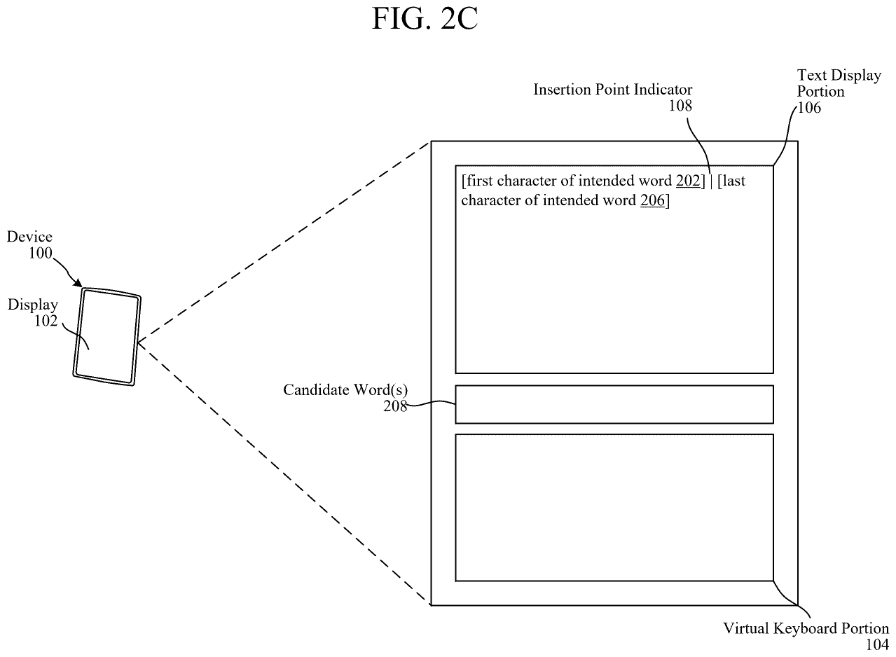

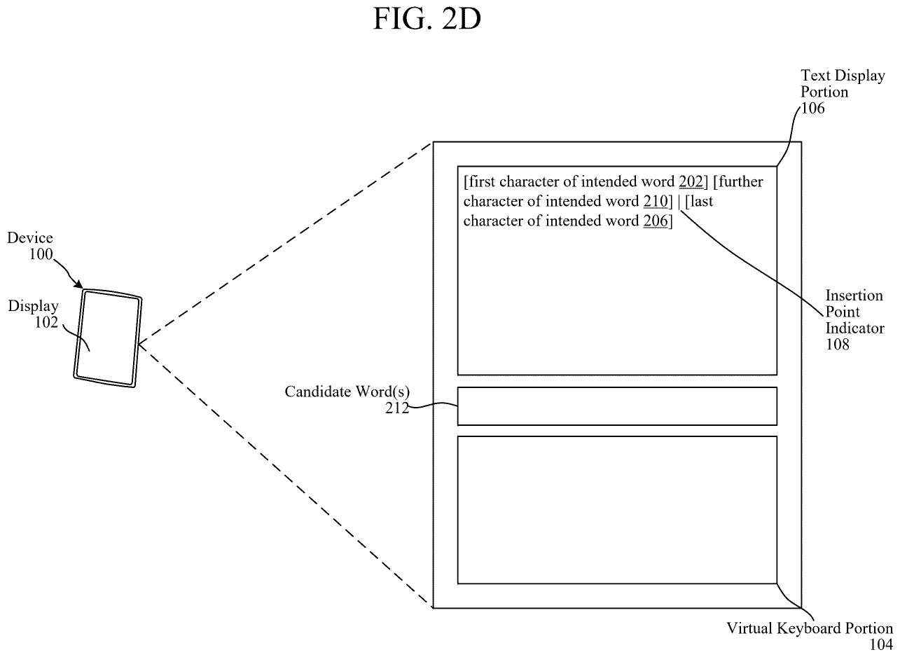

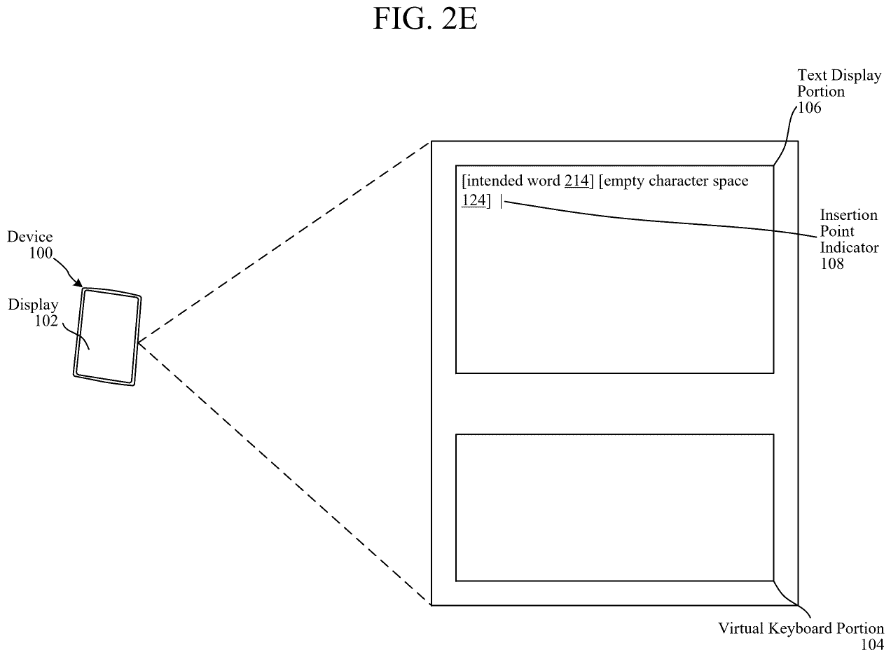

FIGS. 2A-2E illustrate further example display configurations that may be presented to a user in accordance with teachings of the present disclosure. As with the example of FIG. 1A, in the example of FIG. 2A the display 102 may include the virtual keyboard portion 104 where a virtual keyboard is presented and the text display portion 106. Moreover, within the text display portion 106, the insertion point indicator 108 may be presented to indicate to the user where the next input character will be displayed.

Referring to FIG. 2B, in response to receiving the first character input, the device 100 may display the first character 202 in the text display portion 106. The device 100 may further display the insertion point indicator 108 next to (e.g., to the right of) the first character 202 in the text display portion 106. Moreover, in response to receiving the first character input from the user, the device 100 may, as described in detail herein below, determine one or more candidate words 204 starting with the first character 202. The device 100 may display the one or more candidate words 204 using a portion of the display 102.

While the first character 202 of the intended word and the one or more candidate words 204 are displayed, the user may input the last character 206 of the intended word. Referring to FIG. 2C, in response to receiving the last character input, the device 100 may display the last character 206 in the text display portion 106 next to the first character 110. In contrast to FIG. 1C, in FIG. 2C the device 100 may display the insertion point indicator 108 between the first character 102 and the last character 206.

Moreover, in response to receiving the last character input from the user, the device 100 may, as described in detail herein below, determine one or more candidate words 208 starting with the first character 202 and ending with the last character 206. The device 100 may display the one or more candidate words 208 using a portion of the display 102.

While the first character 202 and last character 206 of the intended word and the one or more candidate words 208 are displayed, the user may input a further character 210 of the intended word. The further character 210 may be any character of the intended word that is located between the first character 202 and the last character 206. The further character 210 need not (but can be) the “second” character of the intended word.

In contrast to FIG. 1D, in FIG. 2D the device 100 may, in response to receiving the further character input, display the further character 210 in the text display portion 106 between the further character 202 and the last character 206. Moreover, in contrast to FIG. 1D, in FID. 2D the device 100 may display the insertion point indicator 108 between the further character 210 and the last character 206.

Moreover, in response to receiving the further character input from the user, the device 100 may, as described in detail herein below, determine one or more candidate words 212 starting with the first character 202, ending with the last character 206, and including the further character 210 somewhere between the first character 202 and the last character 206. The device 100 may display the one or more candidate words 212 using a portion of the display 102.

At some point, a displayed candidate word may be the intended word. When this happens, the user may provide an input selecting the candidate word as the intended word. As shown in FIG. 2E, in response to receiving this user input, the device 100 may display the intended word 214 in the text display portion 106. For example, if the user selects a candidate word 204, the device 100 may cease displaying the first character 202 and instead display the intended word 214. For further example, if the user selects a candidate word 208, the device 100 may cease displaying the first character 202 and the last character 206, and instead display the intended word 214. As another example, if the user selects a candidate word 212, the device 100 may cease displaying the first character 202, the last character 206, and the further character 210, and instead display the intended word 214.

Upon displaying the intended word 214, the device 100 may display the insertion point indicator 108 next to (e.g., to the right of) the intended word 214 in the text display portion 106. Moreover, in some embodiments the device 100 may, upon displaying the intended word 214 (and without receiving a separate user input from the one selecting the candidate word as the intended word), display the empty character space 124 between the intended word 214 and the insertion point indicator 108. This prevents the need of the user providing a “space” input to move the insertion point indicator 108 the empty character space 124 away from the intended word 214.

In some embodiments, the device 100 may present to the user, via the display 102, one or more “modulatory” buttons that enable the user to cause the device 100 to perform functions other than single character text input as described above. For example, the device 100 may present a “clear” button, a “speak” button, an “undo” button, and/or an “unscramble” button.

In response to the user selecting the clear button, the device 100 may erase all text in the text display portion 106.

In response to the user selecting the speak button, the device 100 may utilize [e.g., via an application programming interface (API)] a text-to-speech component to generate synthesized speech from the text in the text display portion 106, and output the synthesized speech to the user using one or more speakers of or associated with the device 100. The device 100 may send, to the text-to-speech component, the text to be converted and optionally one or more other attributes, such as a language code, dialect, speaking rate, and/or speaking pitch. The device 100 may write the result to a temporary audio file and output the synthesized speech as audio.

In response to the user selecting the undo button, the device 100 may revert the text display portion 106 to its previous state (e.g., before an intended word was erroneously selected and presented).

The unscramble button may be selected by the user when the device 100 is unable to provide any candidate words (e.g., when the intended word is in a language different from that in the words storage or is a proper noun). In some embodiments, in response to the user selecting the unscramble button, the device 100 may erase all the presently displayed characters of an intended word being input (e.g., typed). In other embodiments, in response to the user selecting the unscramble button, the device 100 may erase all by the first and last characters, of the presently displayed characters, of an intended word being input (e.g., typed). This limits backspace user inputs to remove characters of an intended word being input and limits additional character user inputs. Use of the unscramble button may limit user frustration when the intended word cannot be found.

In some embodiments, the device 100 may present to the user, via the display 102, a “custom codes” modulatory button that enables the user to access a custom codes storage of particular words and/or multi-word phrases commonly spoken by the user. The custom codes storage stores shorthand codes the user configures for certain words and/or multi-word phrases. For example, the user may set a 3-character custom code for a particular 4- or more-character word or multi-word phrase, such that the 4- or more-character word or multi-word phrase is determined and displayed as a candidate word(s) when the three characters of the custom code are input (e.g., typed) by the user. In some embodiments, when the user selects the custom codes button, the device 100 may present a window with a textbox displaying the contents of the user's custom codes.

In some embodiments, the GUI of the device 100 may including a graph used to track message efficiency, which is the quotient of message length and keystrokes. It is equal to 1 for non-speed-enhanced systems (i.e., normal typing), but can be greater than 1 using the herein disclosed text input techniques. By tracking this statistic in real time, the user may observe how the efficiency of their typing changes.

### Device-Implemented Determination and Display of Intended Word

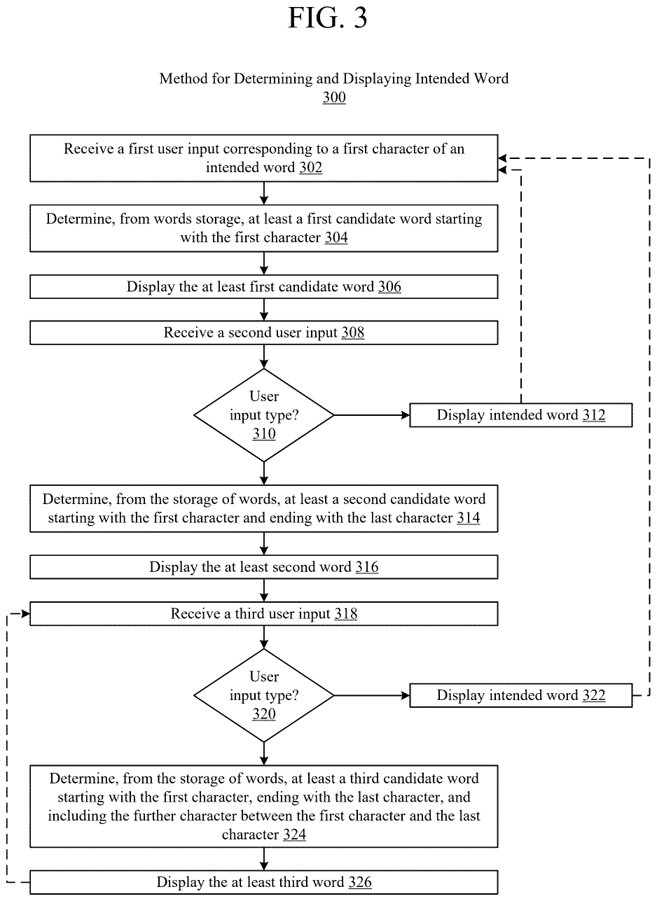

In some implementations, the device 100 may be configured to determine and display an intended word. FIG. 3 is a process flow diagram illustrating a method 300 for determining and displaying an intended word as performed by the device 100.

The device 100 may receive (302) a first user input corresponding to a first character 110/202 of an intended word. The device 100 may optionally display the first character 110/202 as described herein above with respect to FIGS. 1B and 2B.

In response to receiving the first user input, the device 100 may determine (304), from a words storage, at least a first candidate word 112/204 starting with the first character 110/202. For example, in response to receiving the first user input and the first character 110/202 being displayed, the device 100 may determine the closest empty character space to the insertion point indicator 108, determine the first character 110/202 is the only character displayed between the empty character space and the insertion point indicator 108, and in response determine the at least a first candidate word 112/204 starting with the first character 110/202 is to be determined.

The device 100 may query the words storage to identify n first candidate words (e.g., where n equals 1, 2, 3, or some other number of candidate words to be displayed to the user) starting with the first character 110/202. In some embodiments, the device 100 may query the words storage using an API.

The words storage of the present disclosure may be frequency ranked based on frequency of use in the language of the words contained therein. For example, if the words storage includes English words, the words in the words storage may be ordered based on frequency of use in the English language.

In some embodiments, the words storage may be frequency ranked based on a geographic location. For example, if the device 100 is located in or associated with a user whose profile indicates a geographic location of the United States of America, the words in the words storage may be ordered based on frequency of use in the English language as spoken in the United States of America. For further example, if the device 100 is located in or associated with a user whose profile indicates a geographic location of the England, the words in the words storage may be ordered based on frequency of use in the English language as spoken in England.

In some embodiments, the words storage may be frequency-ranked based on a user cohort. User cohorts may be defined in different ways. For example, a user cohort may correspond to users who have a particular disease (e.g., ALS with dysarthria or Parkinson's Disease with dysarthria), users with different levels of literacy, or users with varying language fluency (e.g., English as a second language). Cohorts could also be based on age groups, cultural background, or professional fields, where vocabulary preferences or communication styles might differ significantly. According to these examples, the words in the words storage may be ordered based on frequency of use by the cohort users.

In some embodiments, the words storage may be generated through n-gram analysis of one or more publicly available word corpuses. The data may be loaded, lazily, into RAM, or a generator can be used for parsing large lists as chunks if faster speed is needed.

In response to the query, the words storage may return the at least first candidate word 112/204, where the at least first candidate word 112/204 is the most frequently used candidate word(s) in the words storage that starts with the first character 110/202. For example, if the words storage is queried for 1 word, the words storage may return the most frequently used candidate word starting with the first character 110/202. As another example, if the words storage is queried for 2 words, the words storage may return the 2 most frequently used candidate words starting with the first character 110/202.

In embodiments where the words storage is queried using an API, the words storage may return the at least first candidate word 112/204 via the API.

In response to receiving the at least first candidate word 112/204, the device 100 may display (306) the at least first candidate word 112/204.

While displaying the at least first candidate word 112/204, the device 100 may receive (308) a second user input and determine (310) a type of the second user input. For example, the device 100 may determine whether the second user input selects one of the at least first candidate word 112/204 as the intended word 122/214, selects a modulatory button, or selects the last character 114/206 for the intended word 122/214.

If the device 100 determines the second user input selects one of the at least first candidate word 112/204 as the intended word 122/214, the device 100 may display (312) the intended word 122/214 as described herein above with respect to FIGS. 1E and 2E. Conversely, if the device 100 determines the second user input selects the last character 114/206 for the intended word 122/214, the device 100 may determine (314), from the words storage, at least a second candidate word 116/208 starting with the first character 110/202 and ending with the last character 114/206. For example, in response to receiving the second user input, the device 100 may determine the closest empty character space to the insertion point indicator 108, determine the first character 110/202 and the last character 114/206 are the only two characters displayed between the empty character space and the insertion point indicator 108, and in response determine the at least a second candidate word 116/208 starting with the first character 110/202 and ending with the last character 114/206 is to be determined.

The device 100 may query the words storage to identify n second candidate words (e.g., where n equals 1, 2, 3, or some other number of candidate words to be displayed to the user) starting with the first character 110/202 and ending with the last character 114/206. In some embodiments, the device 100 may query the words storage using an API (which may be the same or a different API as that discussed above with respect to querying for the at least first candidate word 112/204).

In response to the query, the words storage may return the at least second candidate word 116/208, where the at least second candidate word 116/208 is the most frequently used candidate word(s) in the words storage that starts with the first character 110/202 and ends with the last character 114/206. For example, if the words storage is queried for 1 word, the words storage may return the most frequently used candidate word starting with the first character 110/202 and ending with the last character 114/206. As another example, if the words storage is queried for 2 words, the words storage may return the 2 most frequently used candidate words starting with the first character 110/202 and ending with the last character 114/206.

In embodiments where the words storage is queried using an API, the words storage may return the at least second candidate word 116/208 via the API.

In response to receiving the at least second candidate word 116/208, the device 100 may display (316) the at least second candidate word 116/208.

While displaying the at least second candidate word 116/208, the device 100 may receive (318) a third user input and determine (320) a type of the third user input. For example, the device 100 may determine whether the third user input selects one of the at least second candidate word 116/208 as the intended word 122/214, selects a modulatory button, or selects the further character 118/210 for the intended word 122/214.

If the device 100 determines the third user input selects one of the at least second candidate word 116/208 as the intended word 122/214, the device 100 may display (322) the intended word 122/214 as described herein above with respect to FIGS. 1E and 2E. Conversely, if the device 100 determines the third user input selects the further character 118/210 for the intended word 122/214, the device 100 may determine (324), from the words storage, at least a third candidate word 120/212 starting with the first character 110/202, ending with the last character 114/206, and including the further character 118/210 between the first character 110/202 and the last character 114/206. For example, in response to receiving the third user input, the device 100 may determine the closest empty character space to the insertion point indicator 108, determine the first character 110/202, last character 114/206, and further character 118/210 are the only characters displayed between the empty character space and the insertion point indicator 108, and in response determine the at least a third candidate word 120/212 starting with the first character 110/202, ending with the last character 114/206, and including the further character 118/210 between the first character 110/202 and the last character 114/206 is to be determined.

The device 100 may query the words storage to identify n third candidate words (e.g., where n equals 1, 2, 3, or some other number of candidate words to be displayed to the user) starting with the first character 110/202, ending with the last character 114/206, and including the further character 118/210 between the first character 110/202 and the last character 114/206. In some embodiments, the device 100 may query the words storage using an API (which may be the same or a different API as that discussed above with respect to querying for the at least first candidate word 112/204 and/or which may be the same or a different API as that discussed above with respect to querying for the at least second candidate word 116/208).

In response to the query, the words storage may return the at least third candidate word 120/212, where the at least third candidate word 120/212 is the most frequently used candidate word(s) in the words storage that starts with the first character 110/202, ends with the last character 114/206, and includes the further character 118/210 between the first character 110/202 and the last character 114/206. For example, if the words storage is queried for 1 word, the words storage may return the most frequently used candidate word starting with the first character 110/202, ending with the last character 114/206, and including the further character 118/210 between the first character 110/202 and the last character 114/206. As another example, if the words storage is queried for 2 words, the words storage may return the 2 most frequently used candidate words starting with the first character 110/202, ending with the last character 114/206, and including the further character 118/210 between the first character 110/202 and the last character 114/206.

In embodiments where the words storage is queried using an API, the words storage may return the at least third candidate word 120/212 via the API.

In response to receiving the at least second third word 120/212, the device 100 may display (326) the at least third candidate word 120/212.

Steps 318, 320, 324, and 326 may be performed recursively until the user input received at step 318 is the selection of a displayed candidate word (as represented by the dashed arrow from step 326 to step 318). Each time the device 100 determines the user input selects a further character for the intended word 122/214, and the device 100 may determine (324), from the words storage, at least a further candidate word starting with the first character 110/202, ending with the last character 114/206, and including all of the input further characters between the first character 110/202 and the last character 114/206.

The device 100 may determine a candidate word(s) by implementing logic summarized in the following pseudocode:

```
Function(user_query, list_of_words):
  # user_query: The letters that the user inputs into the device (e.g. abc)
  # list_of_words: Any list of words
  if the number of letters in the user_query = 1:
    then define the search_pattern as “\b(?=user_query)\w+\b”
    # Explanation of the search_pattern:
    # \b matches a word boundary
    # (?=user_query) is a positive lookahead that checks if the letter immediately
following the word boundary is the first letter of the intended word
    # \w+ matches one or more word characters
    for a word in the list_of_words:
      if the word satisfies the search_pattern:
        return the word
  if the number of letters in the user_query = 2:
    then define the search_pattern as “\b(?=user_query[0])\w+(?<= user_query[1])\b”
    # user_query[0] is the first letter in the query (e.g. a for ab)
    # user_query[1] is the second letter in the query (e.g. b for ab)
    # Explanation of the search pattern:
    # \b matches a word boundary
    # (?=user_query[0]) is a positive lookahead that checks if the letter immediately
following the word boundary is the first letter of the intended word
    # \w+ matches one or more word characters
    # (?=user_query[1]) is a positive lookbehind that checks if the letter following the
one or more word characters and immediately preceding the forthcoming word boundary \b is
the last letter of the intended word
    for a word in the list_of_words:
      if the word satisfies the search_pattern:
        return the word
  if the number of letters in the user_query > 2:
    then define middle_letters as user_query[2:]
    # user_query[2:] are any letters in the query following the first 2 (e.g. c & e for
    abcde)
    for each letter in middle_letters:
      then define a sub_pattern as “(?=\w+letter)”
      # Explanation of the sub_pattern:
      # (?=\w+letter) is a positive lookahead that checks if the letter is in the
word preceded by any number of other word characters
      then concatenate the sub_pattern to a variable called middle_pattern
    then define the search_pattern as
“\b(?=user_query[0])middle_pattern\w+(?<=user_query[1])\b”
    # user_query[0] is the first letter in the query (e.g. a for abcde)
    # user_query[1] is the second letter in the query (e.g. b for abcde)
    # Explanation of the search_pattern:
    # \b matches a word boundary
    # (?=user_query[0]) is a positive lookahead that checks if the letter immediately
following the word boundary is the first letter of the intended word
    # middle_pattern\w+ matches all of the letters in user_query[2:] which
themselves may be preceded or followed by any number of other word characters
    # (?=user_query[1]) is a positive lookbehind that checks if the letter following the
one or more word characters and immediately preceding the forthcoming word boundary \b is
the last letter of the intended word
    for a word in the list_of_words:
      if the word satisfies the search_pattern:
        return the word
```

These functions match a word boundary (\b) followed by the first character in the query (?=user_query[0]) and any number of word characters (\w+). Depending on the length of the query, this will either be followed by a positive lookbehind for the terminal word character (?<=user_query[1]) and a word boundary (\b), or by a series of middle characters. The functions for these middle characters are generated by recursively concatenating the (?=\w+letter) structure, which matches any number of word characters (\w+) followed by the character of interest. This will also then be followed by a positive lookbehind for the terminal word character (?<=user_query[1]) and a word boundary (\b).

These functions are applied to every word in the frequency-ranked words storage at each of steps 304, 314, and 324, and any matches may be presented in order of decreasing frequency. Any matches may be stored in a list in order of descending frequency. Before this, the device 100 may first compare the query as a string-literal against the words storage (and optionally against keys in a custom codes storage). Any matches from either of these may be appended at the head of the results and take precedence when the device 100 determines which matches (e.g., candidate words) to display.

### System-Implemented Determination and Display of Intended Word

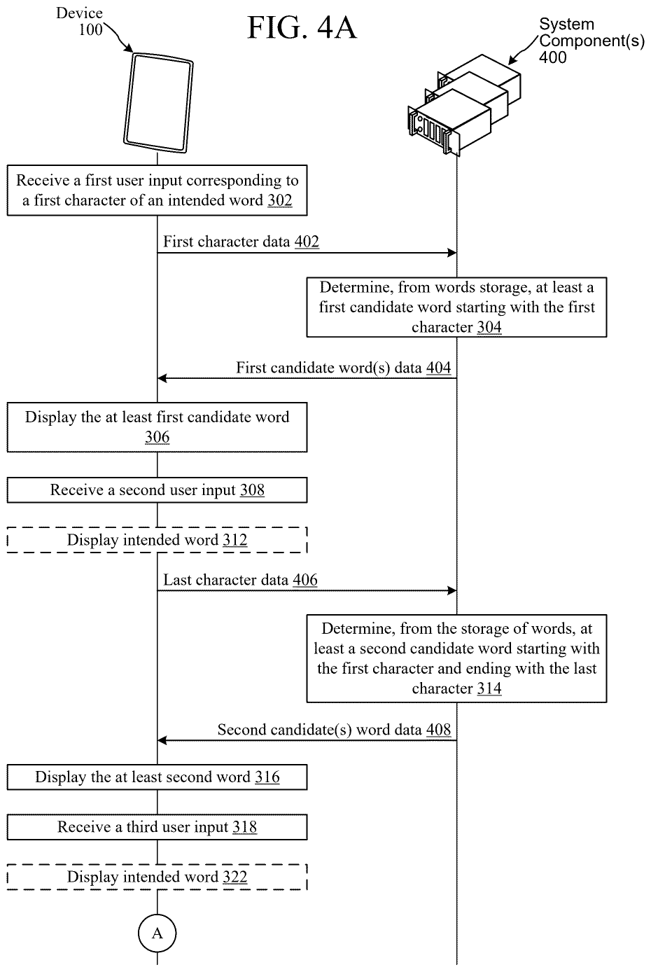

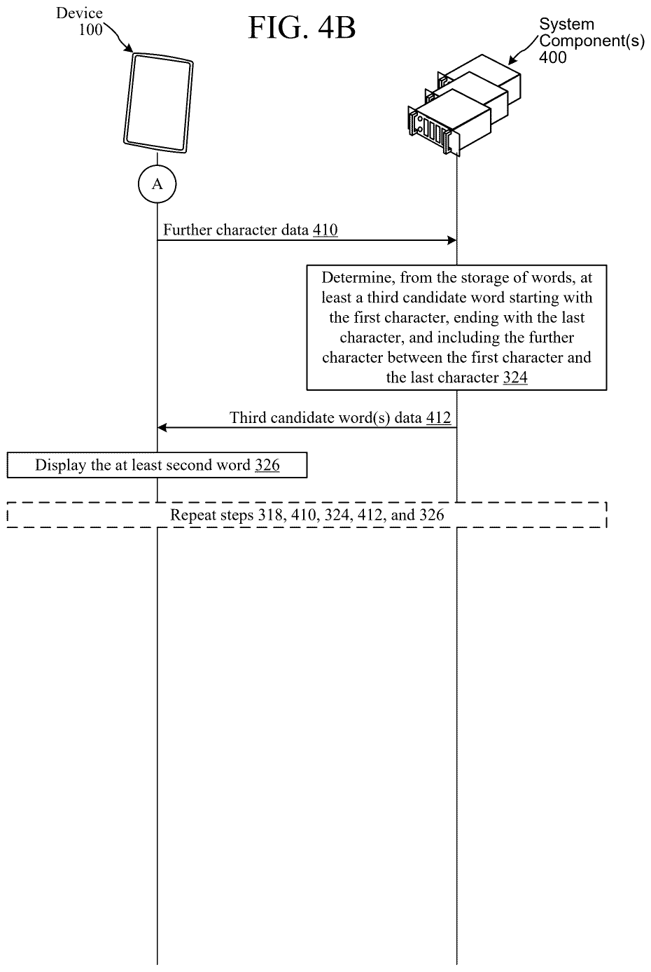

In some implementations, a system, including the device 100 and a system component(s) 400. may be configured to determine and display an intended word. FIGS. 4A-4B illustrate a signal flow for determining and displaying an intended word as performed by the system.

The device 100 may receive (302) a first user input corresponding to a first character 110/202 of an intended word. The device 100 may optionally display the first character 110/202 as described herein above with respect to FIGS. 1B and 2B.

In response to receiving the first user input, the device 100 send (402) first character data to the system component(s) 400. The first character data may include the first character 110/202. The first character data may also include, or be associated with, a device identifier (e.g., serial number) of the device 100. For example, the device 100 may determine the first character data to include the first character 110/202 by determining the closest empty character space to the insertion point indicator 108, and determining the first character 110/202 is the only character displayed between the empty character space and the insertion point indicator 108.

After receiving the first character data, the system component(s) 400 may determine (304), from the words storage, at least a first candidate word 112/204 starting with the first character 110/202. The system component(s) 400 may query the words storage to identify n first candidate words (e.g., where n equals 1, 2, 3, or some other number of candidate words to be displayed to the user) starting with the first character 110/202.

In response to the query, the words storage may return the at least first candidate word 112/204, where the at least first candidate word 112/204 is the most frequently used candidate word(s) in the words storage that starts with the first character 110/202. For example, if the words storage is queried for 1 word, the words storage may return the most frequently used candidate word starting with the first character 110/202. As another example, if the words storage is queried for 2 words, the words storage may return the 2 most frequently used candidate words starting with the first character 110/202.

In response to receiving the at least first candidate word 112/204, the system component(s) 400 may send (404) first candidate word(s) data to the device 110 (e.g., based on the first character data including or being associated with the identifier of the device 110). The first candidate word(s) data includes the at least first candidate word 112/204.

After receiving (and optionally in response to) receiving the first candidate word(s) data, the device 100 may display (306) the at least first candidate word 112/204.

While or after displaying the at least first candidate word 112/204, the device 100 may receive (308) a second user input.

After receiving the second user input, the device 100 may determine a type of the second user input. For example, the device 100 may determine whether the second user input selects one of the at least first candidate word 112/204 as the intended word 122/214, selects a modulatory button, or selects the last character 114/206 for the intended word 122/214.

If the device 100 determines the second user input selects one of the at least first candidate word 112/204 as the intended word 122/214, the device 100 may display (312) the intended word 122/214 as described herein above with respect to FIGS. 1E and 2E. Conversely, if the device 100 determines the second user input selects the last character 114/206 for the intended word 122/214, the device 100 may send (406) last character data to the system component(s) 400. The last character data may include the first character 110/202 and the last character 114/206. The last character data may also include, or be associated with, a device identifier (e.g., serial number) of the device 100. For example, the device 100 may determine the last character data to include the first character 110/202 and the last character 114/206 by determining the closest empty character space to the insertion point indicator 108, and determining the first character 110/202 and the last character 114/206 are the only characters displayed between the empty character space and the insertion point indicator 108.

After receiving the last character data, the system component(s) 400 may determine (314), from the words storage, at least a second candidate word 116/208 starting with the first character 110/202 and ending with the last character 114/206. The system component(s) 400 may query the words storage to identify n second candidate words (e.g., where n equals 1, 2, 3, or some other number of candidate words to be displayed to the user) starting with the first character 110/202 and ending with the last character 114/206.

In response to the query, the words storage may return the at least second candidate word 116/208, where the at least second candidate word 116/208 is the most frequently used candidate word(s) in the words storage that starts with the first character 110/202 and ends with the last character 114/206. For example, if the words storage is queried for 1 word, the words storage may return the most frequently used candidate word starting with the first character 110/202 and ending with the last character 114/206. As another example, if the words storage is queried for 2 words, the words storage may return the 2 most frequently used candidate words starting with the first character 110/202 and ending with the last character 114/206.

In response to receiving the at least second candidate word 116/208, the system component(s) 400 may send (408) second candidate word(s) data to the device 110 (e.g., based on the last character data including or being associated with the identifier of the device 110). The second candidate word(s) data includes the at least second candidate word 116/208.

After receiving (and optionally in response to) the second candidate word(s) data, the device 100 may display (316) the at least second candidate word 116/208.

While or after displaying the at least first candidate word 112/204, the device 100 may receive (318) a third user input.

After receiving the third user input, the device 100 may determine a type of the third user input. For example, the device 100 may determine whether the third user input selects one of the at least second candidate word 116/208 as the intended word 122/214, selects a modulatory button, or selects the further character 118/210 for the intended word 122/214.

If the device 100 determines the third user input selects one of the at least second candidate word 116/208 as the intended word 122/214, the device 100 may display (322) the intended word 122/214 as described herein above with respect to FIGS. 1E and 2E. Conversely, if the device 100 determines the third user input selects the further character 118/210 for the intended word 122/214, the device 100 may send (410) further character data to the system component(s) 400. The further character data may include the first character 110/202, the last character 114/206, and the further character 118/120. The further character data may also include, or be associated with, a device identifier (e.g., serial number) of the device 100. For example, the device 100 may determine the further character data to include the first character 110/202, the last character 114/206, and the further character 118/120 by determining the closest empty character space to the insertion point indicator 108 and determining the first character 110/202, last character 114/206, and further character 118/210 are the only characters displayed between the empty character space and the insertion point indicator 108.

After receiving the further character data, the system component(s) 400 may determine (324), from the words storage, at least a third candidate word 120/212 starting with the first character 110/202, ending with the last character 114/206, and including the further character 118/210 between the first character 110/202 and the last character 114/206. The system component(s) 400 may query the words storage to identify n third candidate words (e.g., where n equals 1, 2, 3, or some other number of candidate words to be displayed to the user) starting with the first character 110/202, ending with the last character 114/206, and includes the further character 118/210 between the first character 110/202 and the last character 114/206.

In response to the query, the words storage may return the at least third candidate word 120/212, where the at least third candidate word 120/212 is the most frequently used candidate word(s) in the words storage that starts with the first character 110/202, ends with the last character 114/206, and includes the further character 118/210 between the first character 110/202 and the last character 114/206. For example, if the words storage is queried for 1 word, the words storage may return the most frequently used candidate word starting with the first character 110/202, ending with the last character 114/206, and including the further character 118/210 between the first character 110/202 and the last character 114/206. As another example, if the words storage is queried for 2 words, the words storage may return the 2 most frequently used candidate words starting with the first character 110/202, ending with the last character 114/206, and includes the further character 118/210 between the first character 110/202 and the last character 114/206.

In response to receiving the at least third candidate word 120/212, the system component(s) 400 may send (412) third candidate word(s) data to the device 110 (e.g., based on the further character data including or being associated with the identifier of the device 110). The third candidate word(s) data includes the at least third candidate word 120/212.

After receiving (and optionally in response to) receiving the third candidate word(s) data, the device 100 may display (326) the at least third candidate word 120/212.

Steps 318, 410, 324, 412, and 326 may be performed recursively until the user input received at step 318 is the selection of a displayed candidate word. Each time the device 100 determines the user input selects a further character for the intended word 122/214, the device may send further character data to the system component(s) 400, and the system component(s) 400 may determine, from the words storage, at least a further candidate word starting with the first character 110/202, ending with the last character 114/206, and including all of the input further characters between the first character 110/202 and the last character 114/206.

The system component(s) 400 may determine a candidate word(s) by implementing logic summarized in the following pseudocode: Function(user_query, list of words):

```
Function(user_query, list_of_words):
  # user_query: The letters that the user inputs into the device (e.g. abc)
  # list_of_words: Any list of words
  if the number of letters in the user_query = 1:
    then define the search_pattern as “\b(?=user_query)\w+\b”
    # Explanation of the search_pattern:
    # \b matches a word boundary
    # (?=user_query) is a positive lookahead that checks if the letter immediately
following the word boundary is the first letter of the intended word
    # \w+ matches one or more word characters
    for a word in the list_of_words:
      if the word satisfies the search_pattern:
        return the word
  if the number of letters in the user_query = 2:
    then define the search_pattern as “\b(?=user_query[0])\w+(?<= user_query[1])\b”
    # user_query[0] is the first letter in the query (e.g. a for ab)
    # user_query[1] is the second letter in the query (e.g. b for ab)
    # Explanation of the search_pattern:
    # \b matches a word boundary
    # (?=user_query[0]) is a positive lookahead that checks if the letter immediately
following the word boundary is the first letter of the intended word
    # \w+ matches one or more word characters
    # (?=user_query[1]) is a positive lookbehind that checks if the letter following the
one or more word characters and immediately preceding the forthcoming word boundary \b is
the last letter of the intended word
    for a word in the list_of_words:
      if the word satisfies the search_pattern:
        return the word
  if the number of letters in the user_query > 2:
    then define middle_letters as user_query[2:]
    # user_query[2:] are any letters in the query following the first 2 (e.g. c & e for
    abcde)
    for each letter in middle letters:
      then define a sub_pattern as “(?=\w+letter)”
      # Explanation of the sub_pattern:
      # (?=\w+letter) is a positive lookahead that checks if the letter is in the
word preceded by any number of other word characters
      then concatenate the sub_pattern to a variable called middle_pattern
    then define the search_pattern as
“\b(?=user_query[0])middle_pattern\w+(?<=user_query[1])\b”
    # user_query[0] is the first letter in the query (e.g. a for abcde)
    # user_query[1] is the second letter in the query (e.g. b for abcde)
    # Explanation of the search_pattern:
    # \b matches a word boundary
    # (?=user_query[0]) is a positive lookahead that checks if the letter immediately
following the word boundary is the first letter of the intended word
    # middle_pattern\w+ matches all of the letters in user_query[2:] which
themselves may be preceded or followed by any number of other word characters
    # (?=user_query[1]) is a positive lookbehind that checks if the letter following the
one or more word characters and immediately preceding the forthcoming word boundary \b is
the last letter of the intended word
    for a word in the list of words:
      if the word satisfies the search_pattern:
        return the word
```

These functions match a word boundary (\b) followed by the first character in the query (?=user_query[0]) and any number of word characters (\w+). Depending on the length of the query, this will either be followed by a positive lookbehind for the terminal word character (?<=user_query[1]) and a word boundary (\b), or by a series of middle characters. The functions for these middle characters are generated by recursively concatenating the (?=\w+letter) structure, which matches any number of word characters (\w+) followed by the character of interest. This will also then be followed by a positive lookbehind for the terminal word character (?<=user_query[1]) and a word boundary (\b).

These functions are applied to every word in the frequency-ranked words storage at each of steps 304, 314, and 324, and any matches may be presented in order of decreasing frequency. Any matches may be stored in a list in order of descending frequency. Before this, the system component(s) 400 may first compare the query as a string-literal against the words storage (and optionally against keys in a custom codes storage). Any matches from either of these may be appended at the head of the results and take precedence when the system component(s) 400 determines which matches (e.g., candidate words) to send to the device 100.

### First Alternative Methodology for Determining Candidate Words

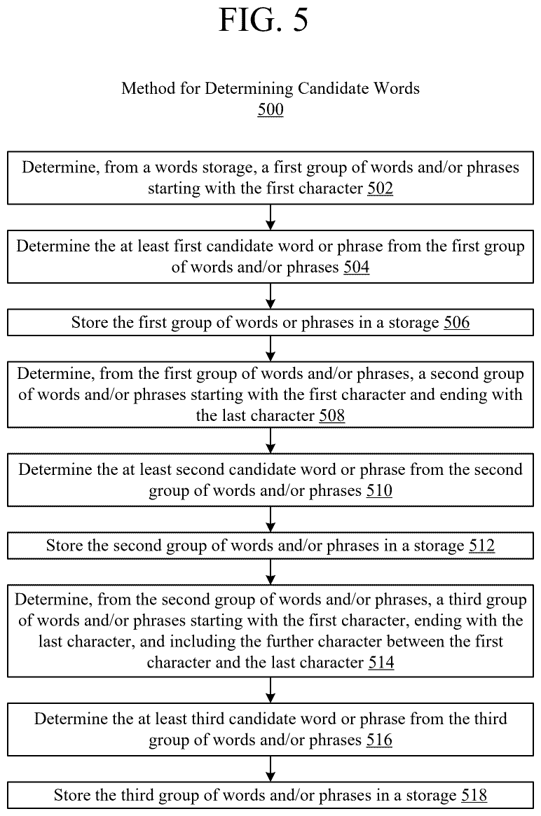

FIG. 5 illustrates another example method 500 for determining candidate words, where the method only involves the device 100 or system component(s) 400 querying the words storage once. In response to the user inputting the first character 110/202, the device 100 or system component(s) 400 may query the words storage to determine (502) a first group of words and/or phrases (i.e., n-grams of words) starting with the first character 110/202. The device 100 or system component(s) 400 may thereafter determine (504) the at least first candidate word 112/204 or phrase from the first group of words or phrases. The device 100 or system component(s) 400 may also store (506) the first group of words or phrases in a storage.

In response to the user inputting the last character 114/206, the device 100 or system component(s) 400 may determine (508), from the first group of words and/or phrases, a second group of words and/or phrases starting with the first character 110/202 and ending with the last character 114/206. The device 100 or system component(s) 400 may thereafter determine (510) the at least second candidate word 116/208 or phrase from the second group of words and/or phrases. The device 100 or system component(s) 400 may also store (512) the second group of words and/or phrases in a storage.

In response to the user inputting the further character 118/210, the device 100 or system component(s) 400 may determine (514), from the second group of words and/or phrases, a third group of words and/or phrases starting with the first character 110/202, ending with the last character 114/206, and including the further character 118/210 between the first character 110/202 and the last character 114/206. The device 100 or system component(s) 400 may thereafter determine (516) the at least third candidate word 120/212 or phrase from the third group of words and/or phrases. The device 100 or system component(s) 400 may also store (518) the third group of words and/or phrases in a storage (i.e., for utilization if the at least third candidate word 120/212 or phrase does not include the intended word 122/214 or phrase and the user inputs yet another further character of the intended word 122/214 or phrase.

### Second Alternative Methodology for Determining Candidate Words

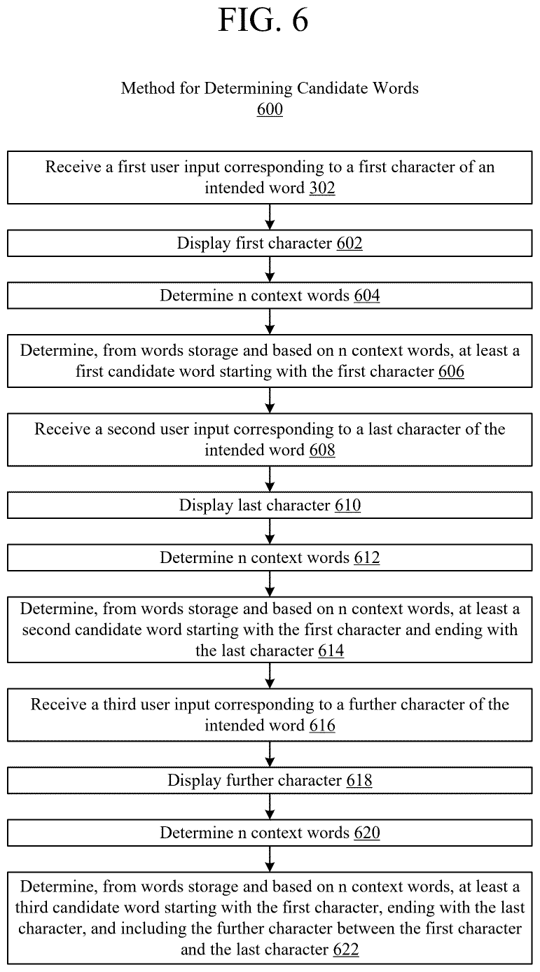

FIG. 6 illustrates another example method 600 for determining candidate words, where n-gram (e.g., bi-gram, tri-gram, etc.) context is used when querying a words storage. In the method 600, the device 100 receives (302) the first user input corresponding to the first character 110/202 of an intended word 122/214. The device 100 also displays (602) the first character 110/202 (as illustrated in and described with respect to FIGS. 1B and 2B).

The device 100 may also determine (604) n context words, where n is 1, 2, 3, 4, etc. The device 100 may determine the n context words to be the word(s) displayed next to (e.g., to the left of) the first character 110/202 in the text display portion 106. For example, the device 100 may determine the single closest word to the first character 110/202 in the text display portion 106. For further example, the device 100 may determine the two closest words to the first character 110/202 in the text display portion 106. As another example, the device 100 may determine the three closest words to the first character 110/202 in the text display portion 106.

The device 100 or system component(s) 400 may include a words storage including words ranked based on frequency of usage in sequence. For example, the words storage may include bi-grams where two words are ranked based on their frequency of usage in sequence. For further example, the words storage may include tri-grams where three words are ranked based on their frequency of usage in sequence.

The device 100 or system component(s) 400 may query the words storage to determine (606), based on the n context words, at least a first candidate word 112/204 starting with the first character 110/202. In some embodiments, the device 100 or system component(s) 400 may determine the at least first candidate word 112/204 based on the n context words being included prior to (e.g., to the left of) the at least first candidate word 112/204 in a bi-gram, tri-gram, etc. in the words storage. The device 100 may also receive (608) a second user input corresponding to the last character 114/206 of the intended word 122/214. The device 100 may display (610) the last character 114/206 (as illustrated in and described with respect to FIGS. 1C and 2C).

The device 100 may also determine (612) n context words, where n is 1, 2, 3, 4, etc. The device 100 may determine the n context words to be the word(s) displayed next to (e.g., to the left of) the first character 110/202 and last character 114/206 in the text display portion 106. For example, the device 100 may determine the single closest word to the first character 110/202 and last character 114/206 in the text display portion 106. For further example, the device 100 may determine the two closest words to the first character 110/202 and last character 114/206 in the text display portion 106. As another example, the device 100 may determine the three closest words to the first character 110/202 and last character 114/206 in the text display portion 106.

The device 100 or system component(s) 400 may query the words storage to determine (614), based on the n context words, at least a second candidate word 116/208 starting with the first character 110/202 and ending with the last character 114/206. In some embodiments, the device 100 or system component(s) 400 may determine the at least second candidate word 116/208 based on the n context words being included prior to (e.g., to the left of) the at least second candidate word 116/208 in a bi-gram, tri-gram, etc. in the words storage.

The device 100 may also receive (616) a third user input corresponding to a further character 118/210 of the intended word 122/214. The device 100 may display (618) the further character 118/210 (as illustrated in and described with respect to FIGS. 1D and 2D).

The device 100 may also determine (620) n context words, where n is 1, 2, 3, 4, etc. The device 100 may determine the n context words to be the word(s) displayed next to (e.g., to the left of) the first character 110/202, last character 114/206, and further character 118/210 in the text display portion 106. For example, the device 100 may determine the single closest word to the first character 110/202, last character 114/206, and further character 118/210 in the text display portion 106. For further example, the device 100 may determine the two closest words to the first character 110/202, last character 114/206, and further character 118/210 in the text display portion 106. As another example, the device 100 may determine the three closest words to the first character 110/202, last character 114/206, and further character 118/210 in the text display portion 106.

The device 100 or system component(s) 400 may query the words storage to determine (622), based on the n context words, at least a third candidate word 120/212 starting with the first character 110/202, ending with the last character 114/206, and including the further character 118/210 between the first character 110/202 and last character 114/206. In some embodiments, the device 100 or system component(s) 400 may determine the at least third candidate word 120/212 based on the n context words being included prior to (e.g., to the left of) the at least third candidate word 120/212 in a bi-gram, tri-gram, etc. in the words storage.

### Third Alternative Methodology for Determining Candidate Words

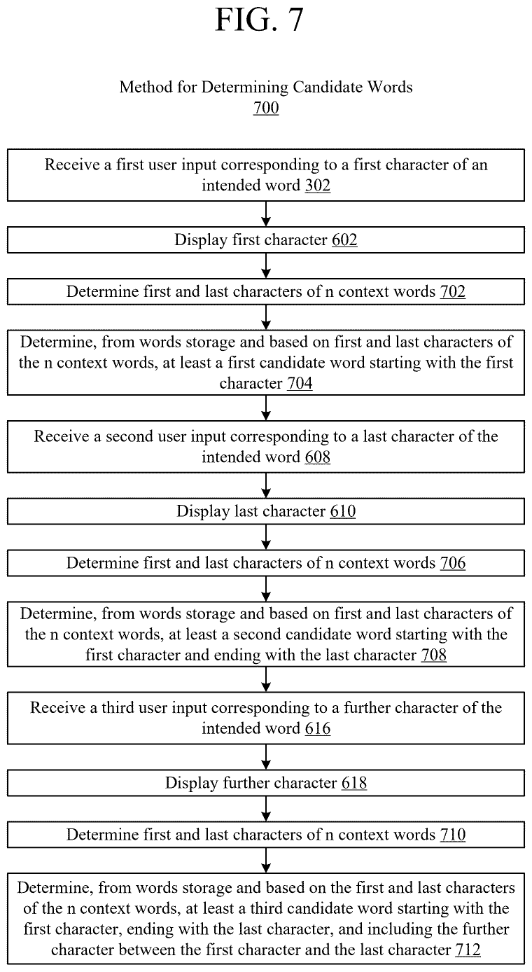

FIG. 7 illustrates a further example method 700 for determining candidate words, where the first and last characters of n-gram (e.g., bi-gram, tri-gram, etc.) context is used when querying a words storage. In the method 700, the device 100 receives (302) the first user input corresponding to the first character 110/202 of an intended word 122/214. The device 100 also displays (602) the first character 110/202 (as illustrated in and described with respect to FIGS. 1B and 2B).

The device 100 may also determine (702) the first and last characters of n context words, where n is 1, 2, 3, 4, etc. The device 100 may determine the n context words to be the word(s) displayed next to (e.g., to the left of) the first character 110/202 in the text display portion 106. For example, the device 100 may determine the first and last characters of a single closest word to the first character 110/202 in the text display portion 106. For further example, the device 100 may determine the first and last characters of the two closest words to the first character 110/202 in the text display portion 106. As another example, the device 100 may determine the first and last characters of the three closest words to the first character 110/202 in the text display portion 106.

The device 100 or system component(s) 400 may include a words storage including words ranked based on frequency of usage in sequence. For example, the words storage may include bi-grams where two words are ranked based on their frequency of usage in sequence. For further example, the words storage may include tri-grams where three words are ranked based on their frequency of usage in sequence.

The device 100 or system component(s) 400 may query the words storage to determine (704), based on the first and last characters of the n context words, at least a first candidate word 112/204 starting with the first character 110/202. In some embodiments, the device 100 or system component(s) 400 may determine the at least first candidate word 112/204 based on the n context words with the determined first and last characters being included prior to (e.g., to the left of) the at least first candidate word 112/204 in a bi-gram, tri-gram, etc. in the words storage.

The device 100 may also receive (608) a second user input corresponding to the last character 114/206 of the intended word 122/214. The device 100 may display (610) the last character 114/206 (as illustrated in and described with respect to FIGS. 1C and 2C).

The device 100 may also determine (706) the first and last characters of n context words, where n is 1, 2, 3, 4, etc. The device 100 may determine the n context words to be the word(s) displayed next to (e.g., to the left of) the first character 110/202 and last character 114/206 in the text display portion 106. For example, the device 100 may determine the first and last characters of the single closest word to the first character 110/202 and last character 114/206 in the text display portion 106. For further example, the device 100 may determine the first and last characters of the two closest words to the first character 110/202 and last character 114/206 in the text display portion 106. As another example, the device 100 may determine the first and last characters of the three closest words to the first character 110/202 and last character 114/206 in the text display portion 106.

The device 100 or system component(s) 400 may query the words storage to determine (708), based on the first and last characters of the n context words, at least a second candidate word 116/208 starting with the first character 110/202 and ending with the last character 114/206. In some embodiments, the device 100 or system component(s) 400 may determine the at least second candidate word 116/208 based on the n context words with the determined first and last characters being included prior to (e.g., to the left of) the at least second candidate word 116/208 in a bi-gram, tri-gram, etc. in the words storage.

The device 100 may also receive (616) a third user input corresponding to a further character 118/210 of the intended word 122/214. The device 100 may display (618) the further character 118/210 (as illustrated in and described with respect to FIGS. 1D and 2D).

The device 100 may also determine (710) the first and last characters of n context words, where n is 1, 2, 3, 4, etc. The device 100 may determine the n context words to be the word(s) displayed next to (e.g., to the left of) the first character 110/202, last character 114/206, and further character 118/210 in the text display portion 106. For example, the device 100 may determine the first and last characters of the single closest word to the first character 110/202, last character 114/206, and further character 118/210 in the text display portion 106. For further example, the device 100 may determine the first and last characters of the two closest words to the first character 110/202, last character 114/206, and further character 118/210 in the text display portion 106. As another example, the device 100 may determine the first and last characters of the three closest words to the first character 110/202, last character 114/206, and further character 118/210 in the text display portion 106.

The device 100 or system component(s) 400 may query the words storage to determine (712), based on the n context words, at least a third candidate word 120/212 starting with the first character 110/202, ending with the last character 114/206, and including the further character 118/210 between the first character 110/202 and last character 114/206. In some embodiments, the device 100 or system component(s) 400 may determine the at least third candidate word 120/212 based on the n context words with the determined first and last characters being included prior to (e.g., to the left of) the at least third candidate word 120/212 in a bi-gram, tri-gram, etc. in the words storage.

### Fourth Alternative Methodology for Determining Candidate Words

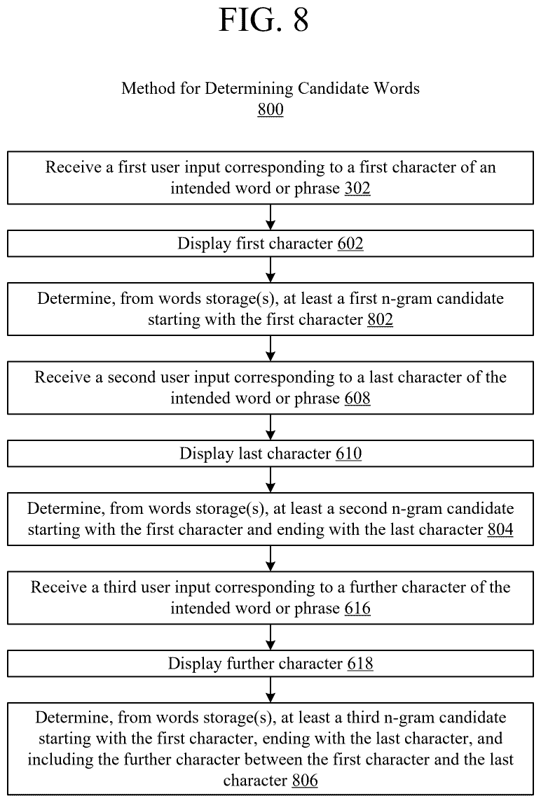

FIG. 8 illustrates another example method 800 for determining candidate words. In the method 800, the device 100 receives (302) the first user input corresponding to the first character 110/202 of an intended word 122/214 or phrase. The device 100 also displays (602) the first character 110/202 (as illustrated in and described with respect to FIGS. 1B and 2B).

The device 100 or system component(s) 400 may include a words storage(s) including character strings ranked based on frequency of usage in sequence. For example, the words storage(s) may include bi-grams where two words are ranked based on their frequency of usage in sequence. For further example, the words storage may include tri-grams where three words are ranked based on their frequency of usage in sequence.

The device 100 or system component(s) 400 may query the words storage(s) to determine (802) at least a first n-gram candidate starting with the first character 110/202. Prior to being searched, the stored n-grams may be manipulated to remove the space positions therein. For example, the 3-gram “how are you” may be converted to “howareyou” prior to being searched. In some embodiments, the device 100 or system component(s) 400 may include a single storage including variously sized n-grams (e.g., 2-grams, 3, grams-4, grams, etc.). In such embodiments, to determine (802) the at least first n-gram candidate, the device 100 or system component(s) 400 may query the single storage for one or more n-gram candidates starting with the first character 110/112. In other embodiments, the device 100 or system component(s) 400 may include a first storage including 2-grams in which the space positions between the words are removed, and/or a second storage including 3-grams in which the space positions between the words are removed, and/or a third storage including 4-grams in which the space positions between the words are removed, etc. In such embodiments, to determine (802) the at least first n-gram candidate, the device 100 or system component(s) 400 may query each of the storages for one or more n-gram candidates starting with the first character 110/112. Again, the n-grams in the one or more storages may be manipulated to remove space positions therein prior to being searched.

Prior to displaying the at least first n-gram candidate, the device 100 or system component(s) 400 may identify the stored n-gram(s) with space positions corresponding to the identified candidate n-gram(s) with space positions removed, and display each n-gram with spacing positions as a different candidate for selection.

The device 100 may also receive (608) a second user input corresponding to the last character 114/206 of the intended word 122/214 or phrase. The device 100 may display (610) the last character 114/206 (as illustrated in and described with respect to FIGS. 1C and 2C).

The device 100 or system component(s) 400 may query the words storage(s) to determine (804) at least a second n-gram candidate starting with the first character 110/202 and ending with the last character 114/206. Prior to being searched, the stored n-grams may be manipulated to remove the space positions therein. In embodiments where the device 100 or system component(s) 400 includes a single storage including variously sized n-grams (e.g., 2-grams, 3, grams-4, grams, etc.), the device 100 or system component(s) 400 may query the single storage for one or more n-gram candidates starting with the first character 110/112 and ending with the last character 114/206. In embodiments where the device 100 or system component(s) 400 includes a first storage including 2-grams in which the space positions between the words are removed, and/or a second storage including 3-grams in which the space positions between the words are removed, and/or a third storage including 4-grams in which the space positions between the words are removed, etc., the device 100 or system component(s) 400 may query each of the storages for one or more n-gram candidates starting with the first character 110/112 and ending with the last character 114/206. Again, the n-grams in the one or more storages may be manipulated to remove space positions therein prior to being searched.

Prior to displaying the at least second n-gram candidate, the device 100 or system component(s) 400 may identify the stored n-gram(s) with space positions corresponding to the identified candidate n-gram(s) with space positions removed, and display each n-gram with spacing positions as a different candidate for selection.

The device 100 may also receive (616) a third user input corresponding to a further character 118/210 of the intended word 122/214 or phrase. The device 100 may display (618) the further character 118/210 (as illustrated in and described with respect to FIGS. 1D and 2D).

The device 100 or system component(s) 400 may query the words storage(s) to determine (806) at least a third n-gram candidate starting with the first character 110/202, ending with the last character 114/206, and including the further character 118/210 between the first character 110/202 and last character 114/206. Prior to being searched, the stored n-grams may be manipulated to remove the space positions therein. In embodiments where the device 100 or system component(s) 400 includes a single storage including variously-sized n-grams (e.g., 2-grams, 3, grams-4, grams, etc.), the device 100 or system component(s) 400 may query the single storage for one or more n-gram candidates starting with the first character 110/112, ending with the last character 114/206, and including the further character 118/210 between the first character 110/202 and last character 114/206. In embodiments where the device 100 or system component(s) 400 includes a first storage including 2-grams in which the space positions between the words are removed, and/or a second storage including 3-grams in which the space positions between the words are removed, and/or a third storage including 4-grams in which the space positions between the words are removed, etc., the device 100 or system component(s) 400 may query each of the storages for one or more n-gram candidates starting with the first character 110/112, ending with the last character 114/206, and including the further character 118/210 between the first character 110/202 and last character 114/206. Again, the n-grams in the one or more storages may be manipulated to remove space positions therein prior to being searched.

Prior to displaying the at least third n-gram candidate, the device 100 or system component(s) 400 may identify the stored n-gram(s) with space positions corresponding to the identified candidate n-gram(s) with space positions removed, and display each n-gram with spacing positions as a different candidate for selection.

The device 100 or system component(s) 400 may determine a candidate word or phrase by implementing logic summarized in the following pseudocode:

```
Function(user_query, list_of_words):
  # user_query: The letters that the user inputs into the device (e.g. abc)
  # list_of_words: Any list of words or n_gram phrases
  if the number of letters in the user_query = 1:
    then define the search_pattern as “\b(?=user_query)\w+\b”
    # Explanation of the search_pattern:
    # \b matches a word boundary
    # (?=user_query) is a positive lookahead that checks if the letter immediately
following the word boundary is the first letter of the intended word
    # \w+ matches one or more word characters
    for a word in the list_of_words:
      then define 1_gram by substituting all “\s+” matches in word with “”
      # “\s+” matches a space which can be replaced by the empty string “”
      if the 1_gram satisfies the search_pattern:
        return the word
if the number of letters in the user_query = 2:
    then define the search_pattern as “\b(?=user_query[0])\w+(?<= user_query[1])\b”
    # user_query[0] is the first letter in the query (e.g. a for ab)
    # user_query[1] is the second letter in the query (e.g. b for ab)
    # Explanation of the search_pattern:
    # \b matches a word boundary
    # (?=user_query[0]) is a positive lookahead that checks if the letter immediately
following the word boundary is the first letter of the intended word
    # \w+ matches one or more word characters
    # (?=user_query[1]) is a positive lookbehind that checks if the letter following the
one or more word characters and immediately preceding the forthcoming word boundary \b is
the last letter of the intended word
    for a word in the list_of_words:
      then define 1_gram by substituting all “\s+” matches in word with “”
      # “\s+” matches a space which can be replaced by the empty string “”
      if the 1_gram satisfies the search_pattern:
        return the word
  if the number of letters in the user_query > 2:
    then define middle_letters as user_query[2:]
    # user_query[2:] are any letters in the query following the first 2 (e.g. c & e for
    abcde)
    for each letter in middle_letters:
      then define a sub_pattern as “(?=\w+letter)”
      # Explanation of the sub_pattern:
      # (?=\w+letter) is a positive lookahead that checks if the letter is in the
word preceded by any number of other word characters
      then concatenate the sub_pattern to a variable called middle_pattern
    then define the search_pattern as
“\b(?=user_query[0])middle_pattern\w+(?<=user_query[1])\b”
    # user_query[0] is the first letter in the query (e.g. a for abcde)
    # user_query[1] is the second letter in the query (e.g. b for abcde)
    # Explanation of the search_pattern:
    # \b matches a word boundary
    # (?=user_query[0]) is a positive lookahead that checks if the letter immediately
following the word boundary is the first letter of the intended word
    # middle_pattern\w+ matches all of the letters in user_query[2:] which
themselves may be preceded or followed by any number of other word characters
    # (?=user_query[1]) is a positive lookbehind that checks if the letter following the
one or more word characters and immediately preceding the forthcoming word boundary \b is
the last letter of the intended word
        for a word in the list_of_words:
      then define 1_gram by substituting all “\s+” matches in word with “”
      # “\s+” matches a space which can be replaced by the empty string “”
      if the 1_gram satisfies the search_pattern:
        return the word
```

### Device and System Component(s) Configurations

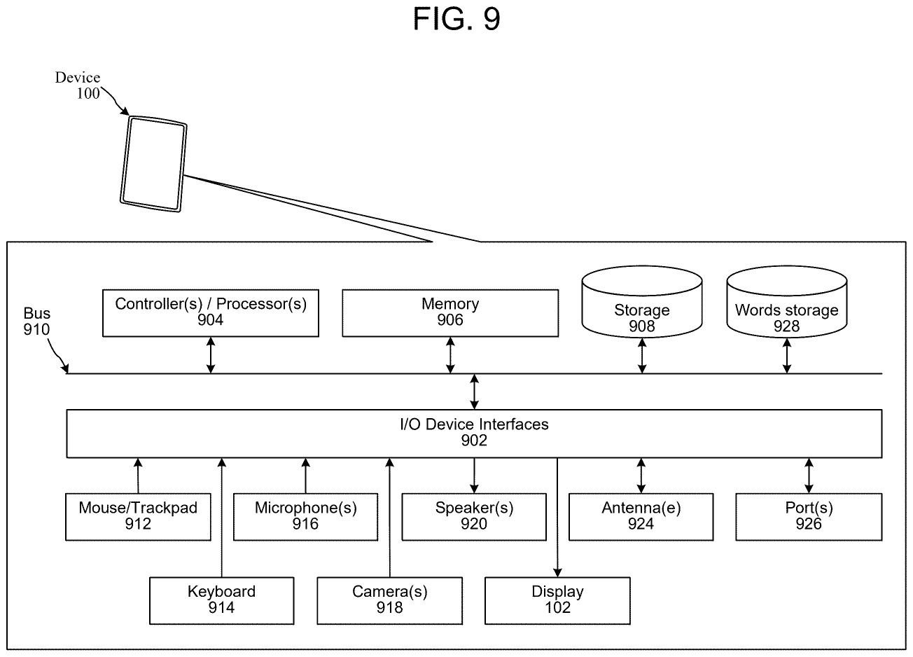

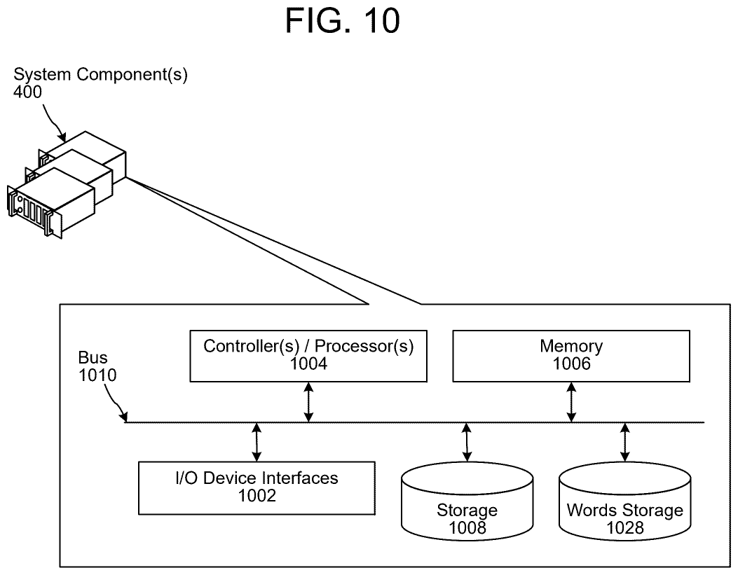

FIG. 9 is a block diagram conceptually illustrating example components of the device 100. FIG. 10 is a block diagram conceptually illustrating example components of the system component(s) 400. The system component(s) 400 may include one or more servers. A “server” as used herein may refer to a traditional server as understood in a server/client computing structure but may also refer to a number of different computing components that may assist with the operations discussed herein. For example, a server may include one or more physical computing components (such as a rack server) that are connected to other devices/components either physically and/or over a network and is capable of performing computing operations. A server may also include one or more virtual machines that emulates a computer system and is run on one or across multiple devices. A server may also include other combinations of hardware, software, firmware, or the like to perform operations discussed herein. The system component(s) 400 may be configured to operate using one or more of a client-server model, a computer bureau model, grid computing techniques, fog computing techniques, mainframe techniques, utility computing techniques, a peer-to-peer model, sandbox techniques, or other computing techniques.

Each of the device 100 and the system component(s) 400 may include one or more controllers/processors (904/1004), which may each include a central processing unit (CPU) for processing data and computer-readable instructions, and a memory (906/1006) for storing data and instructions. The memories (906/1006) may individually include volatile random access memory (RAM), non-volatile read only memory (ROM), non-volatile magnetoresistive memory (MRAM), and/or other types of memory. Each of the device 100 and the system component(s) 400 may also include a data storage component (908/1008) for storing data and controller/processor-executable instructions. Each data storage component (908/1008) may individually include one or more non-volatile storage types such as magnetic storage, optical storage, solid-state storage, etc. Each of the device 100 and the system component(s) 400 may also be connected to removable or external non-volatile memory and/or storage (such as a removable memory card, memory key drive, networked storage, etc.) through respective input/output device interfaces (902/1002).

Computer instructions for operating each of the device 100 and the system component(s) 400 and its various components may be executed by the respective device's controller(s)/processor(s) (904/1004), using the memory (906/1006) as temporary “working” storage at runtime. A device's computer instructions may be stored in a non-transitory manner in non-volatile memory (906/1006), storage (908/1008), or an external device(s). Alternatively, some or all of the executable instructions may be embedded in hardware or firmware on the respective device in addition to or instead of software.

Each of the device 100 and the system component(s) 400 includes input/output device interfaces (902/1002). A variety of components may be connected through the input/output device interfaces (902/1002), as will be discussed further below. Additionally, each of the device 100 and the system component(s) 400 may include an address/data bus (910/1010) for conveying data among components of the respective device. Each component within the device 100 or the system component(s) 400 may also be directly connected to other components in addition to (or instead of) being connected to other components across the bus (910/1010).

Referring to FIG. 9, the device 100 may include input/output device interfaces 902 that connect to a variety of components such as, but not limited to, a mouse and/or trackpad 912, a keyboard 914, one or more microphones 916, one or more cameras 918, one or more speakers 920, the displays 102, one or more antennae 924 (for connecting to one or more networks), and one or more ports 926 for connecting the device 100 to an external device via a wire.

Via the one or more antennae 924, the input/output device interfaces 902 may connect to one or more networks via a wireless local area network (WLAN) (such as Wi-Fi) radio, Bluetooth, and/or wireless network radio, such as a radio capable of communication with a wireless communication network such as a Long Term Evolution (LTE) network, WiMAX network, 3G network, 4G network, 5G network, etc. A wired connection such as Ethernet may also be supported. The input/output device interfaces (902/1002) may also include communication components that allow data to be exchanged between devices, such as different physical servers in a collection of servers or other components.

The device 100 may include a words storage 928 configured as described elsewhere herein. Additionally or alternatively, the system component(s) 400 may include a words storage 1028 configured as described elsewhere herein. In some embodiments, the words storage (928/1028) may store a portion (e.g., 1,000) of the most frequently used words of a language in a buffer. The device 100 or system component 400 may process against the buffer to determine a candidate word(s) and, only if a candidate word cannot be identified in the buffer, the device 100 or system component 400 may process against the words storage (928/1028) containing a larger corpus of the language.

### EXAMPLES

### Example 1. Data Comparing Herein Disclosed Text Input Technique to Control Methods

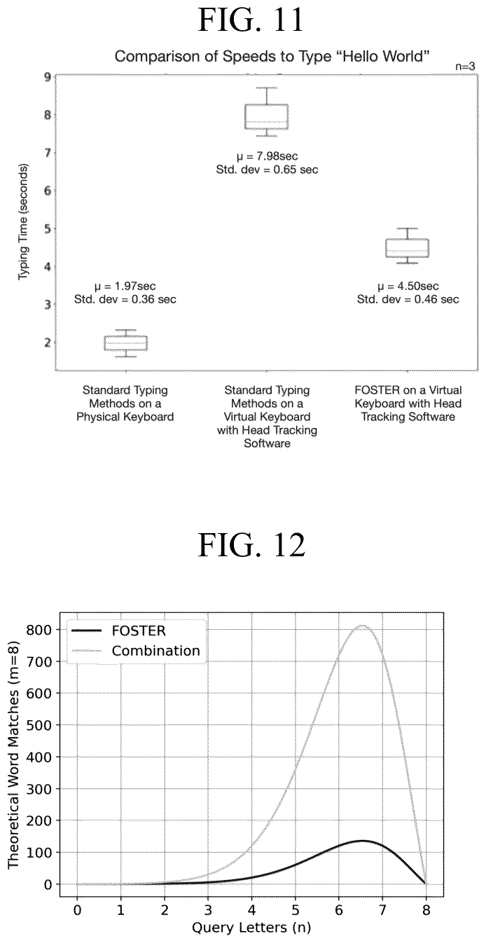

From a video published online by Fabio Dela Antonio in 2023 (“Typing on a virtual keyboard with Eye Tracking #shorts #questpro”, https://www.youtube.com/watch?v=UP1_-Ttc7CA) it was determined that utilizing eye-tracking software and an on-screen keyboard took 15 seconds to type “Hello World”. 3 alternate approaches to typing this same message were tested, specifically using a physical keyboard, an on-screen keyboard with head tracking software, and finally an on-screen keyboard with the herein disclosed text input technique. These preliminary results suggest the herein disclosed text input technique may afford speed increases of >40% (see FIG. 11).

### Example 2. Reduction in Theoretical Word Matches Compared to Combinatorial Approach

For example, suppose the user wants to type the word Inconceivable with length m=13 letters. In both a combinatorial approach as well as the herein disclosed text input technique, it is assumed that the first letter of the word match query corresponds to the first letter of the word.

In the combinatorial approach, where only the position of the first letter is known, the remaining n−1 specified letters must be placed in any of the remaining m−1 positions. Therefore, there are (m−1)!/(m−n)! or 12!/8!(11,880) possible matches. Compare this to the number of possible matches when the position of a second letter is unambiguously specified in the herein disclosed text input technique, where n−2 letters are to be placed in m−2 positions. Here, there are (m−2)!/(m−n)! or 11!/8!(990) possible permutations−one twelfth of the combinatorial approach.

A plot of the number of theoretical word matches (m=8 letters) based on the number of query letters using the combinatorial approach and the herein disclosed text input technique is shown in FIG. 12. On average there is an 83% reduction in theoretical word matches using the herein disclosed text input technique compared to the combinatorial approach for a given number of query characters.

There are two underlying assumptions associated with FIG. 12. The first assumption is that the terminal letter of the word is one of the query letters (E, in the Inconceivable example). The second underlying assumption (in FIGS. 11 and 12) is that all permutations of letters are candidates for potential words.

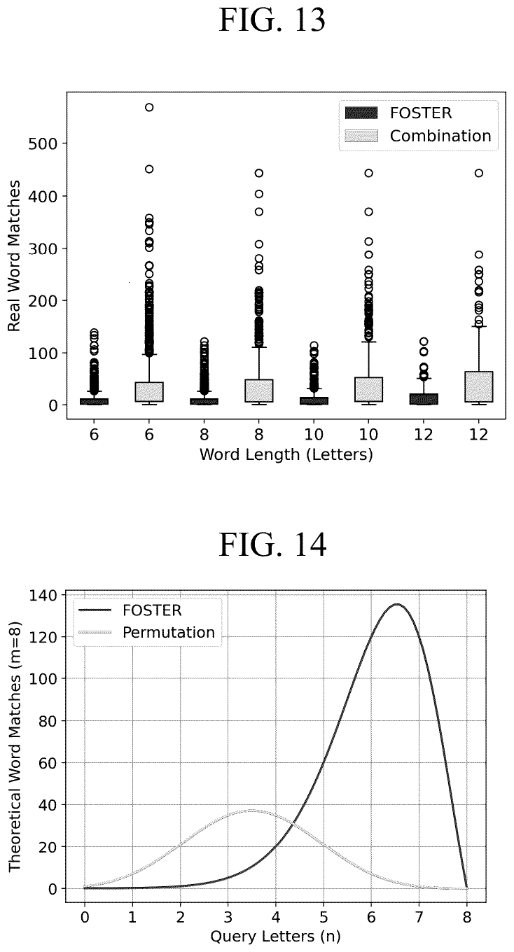

Given the non-random spelling in the English language, a way to distinguish performance of the herein disclosed text input technique and the combinatorial approach is via empirical data. Such data has been obtained by simulating an n=4 letter query against a corpus of 10,000 real English words utilizing both the herein disclosed and combinatorial approaches (see FIG. 13). This data shows that for all 6, 8, 10 and 12 letter words, the herein disclosed text input technique is able to obtain a much smaller list of possible word matches. On average, there is a 71% reduction in possible word matches using the herein disclosed text input technique compared to a combinatorial approach. This aligns with the theoretical maximum reduction of 83%.

### Example 3. Reduction in Theoretical Word Matches Compared to Permutational Approach

A similar theoretical permutational approach can also be calculated. Suppose the user wants to type the word Inconceivable with query letters I, V, B, L and E. Once again it is assumed for the permutational approach that the leading letter of the word is one of the query letters.

As before, the number of possible word matches for the herein disclosed text input technique follows (m−2)!/(m−n)! where n−2 letters are placed in m−2 positions. However, calculating the number of permutational word matches is less intuitive. The idea is to choose n letters from m in a way that maintains their original order, which is essentially choosing n letters out of m without considering the order of selection (since the order is inherently preserved). The number of ways to choose n letters from a list of m while keeping the ascending order is given by the binomial coefficient which can be calculated as m!/(n!(m−n)!).

A plot of the number of theoretical word matches (m=8 letters) based on the number of query letters using the permutational and herein disclosed text input approaches is shown in FIG. 14. In this case, the herein disclosed text input technique returns significantly more (163% increase) possible matches compared to the permutational approach. This can be understood intuitively as there being fewer words that contain the letters in that specific order than there are words which contain those letters anywhere within. This is an extension of the reasoning why the herein disclosed text input technique outperforms the combinatorial method.

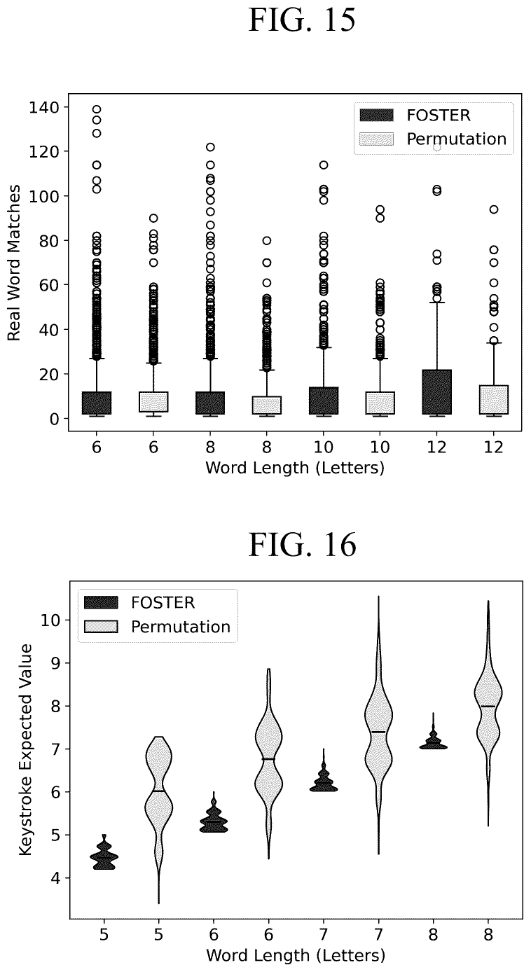

The assumptions noted in Example 2 hold for FIG. 14 and, as a result, empirical data is helpful to accurately determine the performance of the permutational approach. This data was obtained by simulating an n=4 letter query against the corpus of 10,000 English words and is shown in FIG. 15. This data shows that for all 6, 8, 10 and 12 letter words, the herein disclosed text input technique is slightly outperformed by a permutational approach and, on average, there is a 24% increase in possible word matches. Compared to the theoretical maximum increase of 163%, this data suggests that the real-world application of the herein disclosed text input technique mitigates some of the performance lags compared to the permutational approach from a convergence point of view.

However, there is as caveat to the permutational approach that is not accounted for in the data from either FIG. 14 or FIG. 15. Specifically, a unique quality of the permutational approach is that the query length does not imply the number of keystrokes, like it does for the herein disclosed or combinatorial text input methods. This is because in a formatting regime where order fundamentally matters, it is not always possible to append additional query letters at the query string terminus. That is, if the user's intended word is not obtained initially, the inclusion of a new query character to narrow down the results may require additional keystrokes (either the backspace or arrow functions) to place the cursor in the necessary position. In addition to being mentally burdensome, this also means that a significant keystroke penalty may be incurred for certain permutational queries, which is not the case with either the herein disclosed or combinatorial text input approach. This penalty is also not accounted for in either FIG. 14 or FIG. 15. Of course, if the user is able to guess the correct query on the first attempt, the permutational approach may be very effective and not incur any of these backspace keystroke penalties.

Assuming that all permutational queries are equally likely to be used for a given word, an expected value for the number of keystrokes can be calculated which includes the penalty keystrokes for queries which require additional letters. This expected value was calculated by first generating a set of all theoretical permutational queries for a given word. Each of these queries was then used to search through the 10,000 word corpus and return the top match. If the word used to generate the query was the word obtained in this process, then the query was considered successful. The list of failed queries was then compared to the successful ones and the minimum number of keystrokes via a combination of backspaces and/or letters was calculated to transform the failed query into a successful one.

Using the number of keystrokes for each theoretical query, an expected keystroke value was then obtained across all queries. This approach was repeated for all 5,6,7, and 8 letter words in the 10,000-word corpus to generate expected keystroke value distributions for the permutational method. The expected keystroke value was also calculated for the herein disclosed text input technique, which was simply the length of the query string as no backspaces are necessary in this approach. Comparison of these expected values is shown in in FIG. 16, which shows how the herein disclosed text input technique significantly outperforms the permutational method when it comes to the number of keystrokes the user is expected to need to obtain their intended word.

### Further Definitions and Construction of Terms

The titles, headings, and subheadings provided herein should not be interpreted as limiting the various aspects of the disclosure. Accordingly, the terms defined herein are more fully defined by reference to the specification in its entirety. All references cited herein are incorporated by reference in their entirety.

Unless otherwise defined, scientific and technical terms used herein shall have the meanings that are commonly understood by those of ordinary skill in the art. Further, unless otherwise required by context, singular terms shall include pluralities, and plural terms shall include the singular.

In this application, the use of “or” means “and/or” unless stated otherwise. In the context of a multiple dependent claim, the use of “or” refers back to more than one preceding independent or dependent claim in the alternative only.

It is further noted that, as used in this specification and the appended claims, the singular forms “a,” “an,” and “the,” and any singular use of any word, include plural referents unless expressly and unequivocally limited to one referent.

As used herein, the term “about,” means approximately. When the term “about” is used in conjunction with a numerical range, it modifies that range by extending the boundaries above and below the numerical values set forth. Illustratively, the use of the term “about” indicates that values slightly outside the cited values (i.e., plus or minus 0.1% to 10%), which are also effective and safe are included in the value. Numerical ranges recited herein by endpoints include all numbers and fractions subsumed within that range (e.g. 1 to 5 includes 1, 1.5, 2, 2.75, 3, 3.90, 4, and 5).

As used herein, the terms “comprising” (and any form of comprising, such as “comprise,” “comprises,” and “comprised”), “having” (and any form of having, such as “have” and “has”), “including” (and any form of including, such as “includes” and “include”), and “containing” (and any form of containing, such as “contains” and “contain”) are inclusive or open-ended and do not exclude additional, un-recited elements or method steps. Additionally, a term that is used in conjunction with the term “comprising” is also understood to be able to be used in conjunction with the term “consisting of” or “consisting essentially of”

Method steps described in this disclosure can be performed in any order unless otherwise indicated or otherwise clearly contradicted by context.

For the avoidance of doubt, insofar as is practicable any embodiment of a given aspect of the present disclosure may occur in combination with any other embodiment of the same aspect of the present disclosure. In addition, insofar as is practicable it is to be understood that any preferred or optional embodiment of any aspect of the present disclosure should also be considered as a preferred or optional embodiment of any other aspect of the present disclosure.

What is claimed is:

1. A device comprising:
at least one processor; and
at least one memory comprising instructions that, when executed by the at least one processor, cause the device to:
receive a first user input corresponding to a first character of an intended word or phrase to be displayed;
determine, from a words storage, at least a first candidate word or phrase starting with the first character, wherein the words in the words storage are ranked based on a frequency of usage in a language;
display the at least first candidate word or phrase;
while or after displaying the at least first candidate word or phrase, receive a second user input corresponding to a last character of the intended word or phrase;
determine, from the words storage, at least a second candidate word or phrase starting with the first character and ending with the last character; and
display the at least second candidate word.

2. The device of claim 1, wherein the at least one memory further comprises instructions that, when executed by the at least one processor, further cause the device to:
while or after displaying the at least second candidate word or phrase, receive a third user input corresponding to a further character of the intended word or phrase;
determine, from the words storage, at least a third candidate word or phrase starting with the first character, ending with the last character, and including the further character between the first character and the last character; and
display the at least third candidate word or phrase.

3. The device of claim 2, wherein the at least one memory further comprises instructions that, when executed by the at least one processor, further cause the device to, based on receiving the third user input, display the last character between the first character and the further character.

4. The device of claim 2, wherein the at least one memory further comprises instructions that, when executed by the at least one processor, further cause the device to, based on receiving the third user input, display the further character between the first character and the last character.

5. The device of claim 1, wherein the at least one memory further comprises instructions that, when executed by the at least one processor, further cause the device to:
based on receiving the first user input, display the first character; and
based on receiving the second user input:
display the last character next to the first character; and
while displaying the last character next to the first character, display an insertion point indicator of a graphical user interface between the first character and the last character.

6. The device of claim 1, wherein the at least one memory further comprises instructions that, when executed by the at least one processor, further cause the device to:
receive a third user input selecting the second candidate word or phrase; and
based on the third user input, display the second candidate word or phrase as the intended word or phrase with an empty character space positioned between the end of the intended word or phrase and an insertion point indicator of a graphical user interface.

7. The device of claim 1, wherein the instructions for displaying the at least first candidate word or phrase further comprise instructions that, when executed by the at least one processor, further cause the device to display the at least first candidate word or phrase based on the frequency of usage in the language.

8. The device of claim 1, wherein the instructions for displaying the at least second candidate word or phrase further comprise instructions that, when executed by the at least one processor, further cause the device to display the at least second candidate word or phrase based on the frequency of usage in the language.

9. The device of claim 1, wherein the at least one memory further comprises instructions that, when executed by the at least one processor, further cause the device to:
based on the first user input, determine, from the words storage, a group of words or phrases starting with the first character;
store the group of words or phrases in a second storage; and
based on the second user input, determine the at least second candidate word or phrase from the group of words or phrases in the storage.

10. The device of claim 1, wherein the at least one memory further comprises instructions that, when executed by the at least one processor, further cause the device to:
based on receiving the first user input, display the first character;
determine a third word displayed next to the first character; and
determine the at least first candidate word using the third word and the first character.

11. The device of claim 1, wherein the at least one memory further comprises instructions that, when executed by the at least one processor, further cause the device to:
based on receiving the first user input, display the first character of the intended word;
determine a third word displayed next to the first character of the intended word; and
determine the at least first candidate word using the first character of the third word, the last character of the third word, and the first character of the intended word.

12. The device of claim 1, wherein:
the words storage includes n-gram character strings with space positions; and
the at least one memory further comprises instructions that, when executed by the at least one processor, further cause the device to:
generate manipulated n-gram character strings by removing the space positions from the n-gram character strings; and
determine the at least first candidate word or phrase to corresponds to at least a first manipulated n-gram character string starting with the first character.

13. The device of claim 12, wherein the at least one memory further comprises instructions that, when executed by the at least one processor, further cause the device to determine the at least second candidate word or phrase to corresponds to at least a second manipulated n-gram character string starting with the first character and ending with the last character.

14. The device of claim 13, wherein the at least one memory further comprises instructions that, when executed by the at least one processor, further cause the device to:
while or after displaying the at least second candidate word or phrase, receive a third user input corresponding to a further character of the intended word or phrase; and
determine, from the words storage, at least a third candidate word or phrase starting with the first character, ending with the last character, and including the further character between the first character and the last character.

15. The device of claim 1, wherein the frequency of usage in the language corresponds to a cohort of users.

16. A system comprising:
at least one processor; and
at least one memory comprising instructions that, when executed by the at least one processor, cause the system to:
receive, from a user device, a first user input corresponding to a first character of an intended word or phrase to be displayed;
determine, from a words storage, at least a first candidate word starting with the first character, wherein the words in the words storage are ranked based on a frequency of usage in a language;
cause the user device to display the at least first candidate word or phrase;
while or after causing the user device to display the at least first candidate word or phrase, receive a second user input corresponding to a last character of the intended word or phrase;
determine, from the words storage, at least a second candidate word or phrase starting with the first character and ending with the last character; and
cause the user device to display the at least second candidate word.

17. The system of claim 16, wherein the at least one memory further comprises instructions that, when executed by the at least one processor, further cause the system to:
while or after displaying the at least second candidate word or phrase, receive a third user input corresponding to a further character of the intended word;
determine, from the words storage, at least a third candidate word or phrase starting with the first character, ending with the last character, and including the further character between the first character and the last character; and
display the at least third candidate word or phrase.

18. The system of claim 17, wherein the at least one memory further comprises instructions that, when executed by the at least one processor, further cause the system to, based on receiving the third user input, display the last character between the first character and the further character.

19. The system of claim 17, wherein the at least one memory further comprises instructions that, when executed by the at least one processor, further cause the system to, based on receiving the third user input, display the further character between the first character and the last character.

20-30. (canceled)

31. A computer-implemented method comprising:
receiving a first user input corresponding to a first character of an intended word or phrase to be displayed;
determining, from a words storage, at least a first candidate word or phrase starting with the first character, wherein the words in the words storage are ranked based on a frequency of usage in a language;
displaying the at least first candidate word or phrase;
while or after displaying the at least first candidate word or phrase, receiving a second user input corresponding to a last character of the intended word or phrase;
determining, from the words storage, at least a second candidate word or phrase starting with the first character and ending with the last character; and
displaying the at least second candidate word.

32-60. (canceled)
